(19) United States
(12) Patent Application Publication
(10) Pub. No.: US 2004/0267897 A1
(43) Pub. Date: Dec. 30, 2004

(54) Distributed System Providing Scalable Methodology for Real-Time Control of Server Pools and Data Centers

(75) Inventors: Jonathan M. D. Hill, Oxford (GB); William F. McColl, Oxford (GB); Radu Calinescu, Oxford (GB); Paul Scammell, Palo Alto, CA (US); Richard McPhee, San Francisco, CA (US)

Correspondence Address: JOHN A. SMART, 708 BLOSSOM HILL RD., #201, LOS GATOS, CA, 95032, US

(73) Assignee: SYCHRON INC., San Mateo, CA (US)

(21) Appl. No.: 10/605,938

(22) Filed: Nov. 6, 2003

Related U.S. Application Data
(60) Provisional application No. 60/481,019, filed on Jun. 24, 2003.

(51) Int. Cl. G06F 15/16

(52) U.S. Cl. 709/217

(57) ABSTRACT

A distributed system providing scalable methodology for real-time control of server pools and data centers is described. In one embodiment, a method is described for regulating resource usage by a plurality of programs running on a plurality of machines, the method comprises steps of: providing a resource policy specifying allocation of resources amongst the plurality of programs; determining resources available at the plurality of machines; detecting requests for resources by each of the plurality of programs running on each of the plurality of machines; periodically exchanging resource information amongst the plurality of machines, the resource information including requests for resources and resource availability at each of the plurality of machines; and at each of the plurality of machines, allocating resources to each program based upon the resource policy and the resource information.

### CROSS REFERENCE TO RELATED APPLICATIONS

The present application is related to and claims the benefit of priority of the following commonly-owned, presently-pending provisional application(s): application Ser. No. 60/481,019 (Docket No. SYCH/0002.00), filed Jun. 24, 2003, entitled “Distributed System Providing Scalable Methodology for Real-Time Control of Server Pools and Data Centers”, of which the present application is a non-provisional application thereof. The disclosure of the foregoing application is hereby incorporated by reference in its entirety, including any appendices or attachments thereof, for all purposes.

### COPYRIGHT STATEMENT

A portion of the disclosure of this patent document contains material which is subject to copyright protection.

The copyright owner has no objection to the facsimile reproduction by anyone of the patent document or the patent disclosure as it appears in the Patent and Trademark Office patent file or records, but otherwise reserves all copyright rights whatsoever.

### APPENDIX DATA

Computer Program Listing Appendix under Sec. 1.52(e): This application includes a transmittal under 37 C.F.R. Sec. 1.52(e) of a Computer Program Listing Appendix. The Appendix, which comprises text file(s) that are IBM-PC machine and Microsoft Windows Operating System compatible, includes the below-listed file(s). All of the material disclosed in the Computer Program Listing Appendix can be found at the U.S. Patent and Trademark Office archives and is hereby incorporated by reference into the present application.

Object Description: SourceCode.txt, created Oct. 21, 2003, 9:51 am, size: 24.9 KB; Object ID: File No. 1; Object Contents: Source Code.

### BACKGROUND OF INVENTION

1. Field of the Invention

The present invention relates generally to information processing environments and, more particularly, to a distributed system providing a scalable methodology for the real-time control of server pools and data centers.

2. Description of the Background Art

Many of today's leading businesses are looking to accelerate their critical processes to provide real-time levels of responsiveness, in which there is no delay between events and the responses to them. The real-time enterprise can instantly connect customers, suppliers, partners and employees to business processes and to analytics for decision-making. It has continuous real-time visibility into all critical areas of the business, including sales, inventory, costs, markets, and competition. By reducing response times, inefficiencies and costs are also reduced. Real-time responsiveness enables a business to adjust plans on the fly in reaction to changes in demand, supply, competition, pricing, interest rates, oil prices, weather, stock markets and other parameters. By sensing changes earlier and in more detail, businesses can reduce risk and increase competitive advantage. In cases where a business process is customer-facing, real-time responsiveness leads to a greatly enhanced customer experience which can result in increased customer loyalty.

In recent years, users are increasingly demanding that their information technology (IT) systems provide this level of real-time responsiveness. In response, the timescales for handling a number of different types of critical business processes such as trading analytics, call center inquiries, tracking finances, supply chain updates, and data warehouse renewal have been reduced from hours or days to minutes or even seconds. For example, one recent report indicated that for the four year period from 1998 to 2002, the timescale for call center inquiries had been reduced from 8 hours to 10 seconds, a reduction of 2880 times. Over the same four-year period, the timescale for data warehouse renewal had been reduced from one month to one hour, an acceleration of 720 times.

These massive and sudden changes in the speed of business pose major challenges for the underlying distributed server infrastructure that powers today's businesses. A significant increase in the degree of responsiveness that server pools and data centers can provide is required to address these changes in the speed of business.

Another major problem facing data centers today is the growing cost of providing IT services. The source of one of the most costly problems is the administration of a multiple tier (n-tier) server architecture typically used today by businesses and other organizations, in which each tier conducts a specialized function as a component part of an IT service. In this type of multiple tier environment, one tier might, for example, exist for the front-end web server function, while another tier supports the mid-level applications such as shopping cart selection in an Internet electronic commerce (eCommerce) service. A back-end data tier might also exist for handling purchase transactions for customers. The advantages of this traditional n-tier approach to organizing a data center are that the tiers provide dedicated bandwidth and CPU resources for each application. The tiers can also be isolated from each other by firewalls to control routable Internet Protocol traffic being forwarded inappropriately from one application to another.

There are, however, a number of problems in maintaining and managing all of these tiers in a data center. First, each tier is typically managed as a separate pool of servers which adds to the administrative overhead of managing the data center. Each tier also generally requires over-provisioned server and bandwidth resources to maintain availability as well as to handle unanticipated user demand. Despite the fact that the cost of servers and bandwidth continues to fall, tiers are typically isolated from one another in silos, which makes sharing over-provisioned capacity difficult and leads to low resource utilization under normal conditions. For example, one “silo” (e.g., a particular server) may, on average, be utilizing only twenty percent of its CPU capacity. It would be advantageous to harness this surplus capacity and apply it to other tasks.

Currently, the overall allocation of server resources to applications is performed by separately configuring and reconfiguring each required resource in the data center. In particular, server resources for each application are managed separately. The configuration of other components that link the servers together such as traffic shapers, load balancers, and the like is also separately managed in most cases. In addition, each one of these separately managed re-configurations is also typically performed without any direct linkage to the business goals of the configuration change.

Many server vendors are promoting the replacement of multiple small servers with fewer, larger servers as a solution to the problem of server over-provisioning. This approach alleviates some of these administration headaches by replacing the set of separately managed servers with either a single server or a smaller number of servers. However, it does not provide any relief for application management since each one still needs to be isolated from the others using either hardware or software boundaries to prevent one application consuming more than its appropriate share of the resources.

Hardware boundaries (also referred to by some vendors as “dynamic system domains”) allow a server to run multiple operating system (OS) images simultaneously by partitioning the server into logically distinct resource domains at the granularity of the CPU, memory, and Input/Output cards. With this dynamic system domain solution, however, it is difficult to dynamically move CPU resources between domains without, for example, also moving some Input/Output ports. This type of resource reconfiguration must be performed manually by the server administrator rather than automatically by the application's changing demand for resources.

Existing software boundary mechanisms allow resources to be re-configured more dynamically than hardware boundaries. However, current software boundary mechanisms apply only to the resources of a single server. Consequently, a data center which contains many servers still has the problem of managing the resource requirements of applications running across multiple servers, and of balancing load between them.

Today, if a business goal is to provide a particular application with a certain priority for resources so that it can sustain a required level of service to customers, then the only controls available to the administrator to effect this change are focused on the resources rather than on the application. For example, to allow a particular application to deliver faster response time, adjusting a traffic shaper to permit more of the application's traffic type on the network may not necessarily result in the desired level of service. The bottleneck may not be bandwidth-related; instead it may be that additional CPU resources are also required. As another example, the performance problem may result from the behavior of another program in the data center which generates the same traffic type as the priority application. Improving performance may require constraining resource usage by this other program.

Another problem in current data center environments is that monitoring historical use of the resources consumed by applications (e.g., to provide capacity planning data or for billing and charge-back reporting) is difficult since there is no centralized monitoring of the data center resources. Currently, data from different collection points is typically collected and correlated manually in order to try to obtain a consistent view of resource utilization.

A solution is required that enables resource capacity to be balanced between and amongst tiers in a data center, thereby reducing the cost inefficiencies of isolated server pools. The solution should enable resource allocation to be aligned with, and driven by, business priorities and policies, which may of course be changing over time. Ideally, the solution should promptly react to changing priorities and new demands while providing guaranteed service levels to ensure against system downtime. While providing increased ability to react to changes, the solution should also enable the costs of operating a data center to be reduced. The present invention provides a solution for these and other needs.

### SUMMARY OF INVENTION

In one embodiment, a method of the present invention is described for regulating resource usage by a plurality of programs running on a plurality of machines, the method comprises steps of: providing a resource policy specifying allocation of resources amongst the plurality of programs; determining resources available at the plurality of machines; detecting requests for resources by each of the plurality of programs running on each of the plurality of machines; periodically exchanging resource information amongst the plurality of machines, the resource information including requests for resources and resource availability at each of the plurality of machines; and at each of the plurality of machines, allocating resources to each program based upon the resource policy and the resource information.

In another embodiment, a system of the present invention is described for regulating utilization of computer resources of a plurality of computers, the system comprises: a plurality of computers having resources to be regulated which are connected to each other through a network; a monitoring module provided at each computer having resources to be regulated, for monitoring resource utilization and providing resource utilization information to each other connected computer having resources to be regulated; a manager module providing rules governing utilization of resources available on the plurality of computers and transferring the rules to the plurality of computers; and an enforcement module at each computer for which resources are to be regulated for regulating usage of resources based on the transferred rules and the resource utilization information received from other connected computers.

In yet another embodiment, a method of the present invention is described for scheduling communications by a plurality of applications running on a plurality of computers connected to each other through a network, the method comprises steps of: providing a policy specifying priorities for scheduling communications by the plurality of applications; periodically determining communication resources available at the plurality of computers; at each of the plurality of computers, detecting requests to communicate and identifying a particular application associated with each request; exchanging bandwidth information amongst the plurality of computers, the bandwidth information including applications making the requests to communicate and a measure of communications resources required to fulfill the requests; and at each of the plurality of computers, scheduling communications based upon the policy and the bandwidth information.

### BRIEF DESCRIPTION OF DRAWINGS

FIG. 1 is a block diagram of a computer system in which software-implemented processes of the present invention may be embodied.

FIG. 2 is a block diagram of a software system for controlling the operation of the computer system.

FIG. 3A is a utilization histogram illustrating how the CPU utilization of a particular application was distributed over ti me.

FIG. 3B is a utilization chart illustrating the percentage of CPU resources used by an application on a daily basis over a period of time.

FIG. 3C is a utilization chart for a first application over a certain period of time.

FIG. 3D is a utilization chart for a second application over a certain period of time.

FIG. 3E is a combined utilization chart illustrating the combination of the two applications shown at FIGS. 3C-D on the same set of resources.

FIG. 4 is a block diagram of a typical server pool in which several servers are interconnected via one or more switches or routers.

FIG. 5 is a block diagram illustrating the interaction between the kernel modules of the system of the present invention and certain existing operating system components.

FIG. 6 is a block diagram illustrating the user space modules or daemons of the system of the present invention.

### DETAILED DESCRIPTION

Glossary

The following definitions are offered for purposes of illustration, not limitation, in order to assist with understanding the discussion that follows.

Burst capacity: The “burst capacity” or “headroom” of a program (e.g., an application program) is a measure of the extra resources (i.e., resources beyond those specified in the resource policy) that may potentially be available to the program should the extra resources be idle. The headroom of an application is a good indication of how well it may be able to cope with sudden spikes in demand. For example, an application running on a single server whose resource policy guarantees that 80% of the CPU resources are allocated to this application has 20% headroom. However, a similar application running on two servers whose policy guarantees it 40% of the resources of each CPU has headroom of 120% (i.e., 2×60%).

Flow: A “flow” is a subset of network traffic which usually corresponds to a stream (e.g., Transmission Control Protocol/Internet Protocol or TCP/IP), connectionless traffic (User Datagram Protocol/Internet Protocol or UDP/IP), or a group of such connections or patterns identified over time. A flow consumes the resources of one or more pipes.

Network: A “network” is a group of two or more systems linked together. There are many types of computer networks, including local area networks (LANs), virtual private networks (VPNs), metropolitan area networks (MANs), campus area networks (CANs), and wide area networks (WANs) including the Internet. As used herein, the term “network” refers broadly to any group of two or more computer systems or devices that are linked together from time to time (or permanently).

Pipe: A “pipe” is a shared network path for network (e.g., Internet Protocol) traffic which supplies inbound and outbound network bandwidth. Pipes are typically shared by all servers in a server pool. It should be noted that in this document the term “pipes” refers to a network communication channel and should be distinguished from the UNIX concept of pipes for sending data to a particular program (e.g., a command line symbol meaning that the standard output of the command to the left of the pipe gets sent as standard input of the command to the right of the pipe).

Resource policy: An application resource usage policy (referred to herein as a “resource policy”) is a specification of the resources which are to be delivered to particular programs (e.g., applications or application instances). A resource policy applicable to a particular program (e.g., application) is typically defined in one of two ways: the first is based on a proportion of the server pool's total resources to be made available to the application, namely, pipes (i.e., bandwidth) and aggregated server resources; the second is based on a proportion of the pipes (bandwidth) and individual server resources used by the application. In either case, the proportion of a resource to be allocated to a given application is generally specified either as an absolute value, in the appropriate units of the resource, or as a percentage relative to the current availability of the appropriate resource.

Server pool: A “server pool” is a collection of one or more servers and a collection of one or more pipes. A server pool aggregates the resources supplied by one or more servers. A server is a physical machine which supplies CPU and memory resources. Computing resources of the server pool are consumed by one or more programs (e.g., application programs) which run in the server pool.

TCP: “TCP” stands for Transmission Control Protocol. TCP is one of the main protocols in TCP/IP networks. Whereas the IP protocol deals only with packets, TCP enables two hosts to establish a connection and exchange streams of data. TCP guarantees delivery of data and also guarantees that packets will be delivered in the same order in which they were sent. For an introduction to TCP, see e.g., “RFC 793: Transmission Control Program DARPA Internet Program Protocol Specification”, the disclosure of which is hereby incorporated by reference. A copy of RFC 793 is currently available via the Internet (e.g., at www.ietf.org/rfc/rfc793.txt).

TCP/IP: “TCP/IP” stands for Transmission Control Protocol/Internet Protocol, the suite of communications protocols used to connect hosts on the Internet. TCP/IP uses several protocols, the two main ones being TCP and IP. TCP/IP is built into the UNIX operating system and is used by the Internet, making it the de facto standard for transmitting data over networks. For an introduction to TCP/IP, see e.g., “RFC 1180: A TCP/IP Tutorial,” the disclosure of which is hereby incorporated by reference. A copy of RFC 1180 is currently available via the Internet (e.g., at www.ietf.org/rfc/rfc1180.txt).

XML: “XML” stands for Extensible Markup Language, a specification developed by the World Wide Web Consortium W3C). XML is a pared-down version of the Standard Generalized Markup Language (SGML), a system for organizing and tagging elements of a document. XML is designed especially for Web documents. It allows designers to create their own customized tags, enabling the definition, transmission, validation, and interpretation of data between applications and between organizations. For further description of XML, see e.g., “Extensible Markup Language guage (XML) 1.0”, (2nd Edition, Oct. 6, 2000) a recommended specification from the W3C, the disclosure of which is hereby incorporated by reference. A copy of this specification is currently available via the Internet (e.g., at www.w3.org/TR/2000/REC-xml-20001006).

Introduction

The following description will focus on the presently preferred embodiment of the present invention, which is implemented in desktop and/or server software (e.g., driver, application, or the like) operating in an Internet-connected environment running under an operating system, such as the Microsoft Windows operating system. The present invention, however, is not limited to any one particular application or any particular environment. Instead, those skilled in the art will find that the system and methods of the present invention may be advantageously embodied on a variety of different platforms, including Macintosh, Linux, Solaris, UNIX, FreeBSD, and the like. Therefore, the description of the exemplary embodiments that follows is for purposes of illustration and not limitation. The exemplary embodiments are primarily described with reference to block diagrams or flowcharts. As to the flowcharts, each block within the flowcharts represents both a method step and an apparatus element for performing the method step. Depending upon the implementation, the corresponding apparatus element may be configured in hardware, software, firmware or combinations thereof.

Computer-Based Implementation

Basic system hardware (e.g., for desktop and server computers)

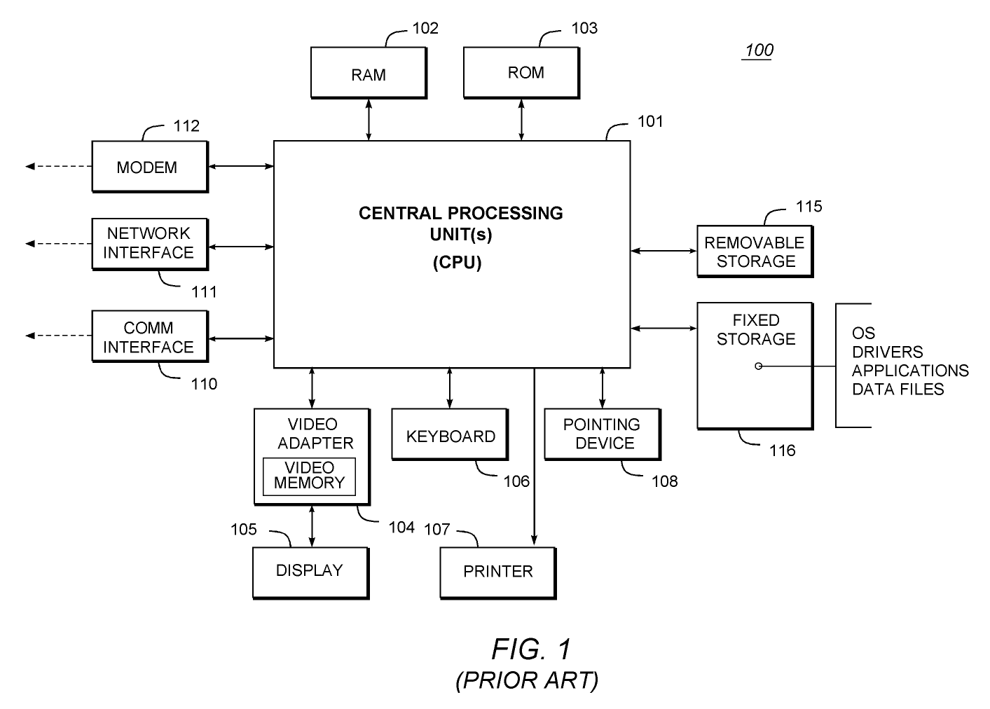

The present invention may be implemented on a conventional or general-purpose computer system, such as an IBM-compatible personal computer (PC) or server computer. FIG. 1 is a very general block diagram of an IBM-compatible system 100. As shown, system 100 comprises a central processing unit(s) (CPU) or processor(s) 101 coupled to a random-access memory (RAM) 102, a read-only memory (ROM) 103, a keyboard 106, a printer 107, a pointing device 108, a display or video adapter 104 connected to a display device 105, a removable (mass) storage device 115 (e.g., floppy disk, CD-ROM, CD-R, CD-RW, DVD, or the like), a fixed (mass) storage device 116 (e.g., hard disk), a communication (COMM) port(s) or interface(s) 110, a modem 112, and a network interface card (NIC) or controller 111 (e.g., Ethernet). Although not shown separately, a real time system clock is included with the system 100, in a conventional manner.

CPU 101 comprises a processor of the Intel Pentium family of microprocessors. However, any other suitable processor may be utilized for implementing the present invention. The CPU 101 communicates with other components of the system via a bi-directional system bus (including any necessary input/output (I/O) controller circuitry and other “glue” logic). The bus, which includes address lines for addressing system memory, provides data transfer between and among the various components. Description of Pentium-class microprocessors and their instruction set, bus architecture, and control lines is available from Intel Corporation of Santa Clara, Calif. Random-access memory 102 serves as the working memory for the CPU 101. In a typical configuration, RAM of sixty-four megabytes or more is employed. More or less memory may be used without departing from the scope of the present invention. The read-only memory (ROM) 103 contains the basic input/output system code (BIOS)—a set of low-level routines in the ROM that application programs and the operating systems can use to interact with the hardware, including reading characters from the keyboard, outputting characters to printers, and so forth.

Mass storage devices 115, 116 provide persistent storage on fixed and removable media, such as magnetic, optical or magnetic-optical storage systems, flash memory, or any other available mass storage technology. The mass storage may be shared on a network, or it may be a dedicated mass storage. As shown in FIG. 1, fixed storage 116 stores a body of program and data for directing operation of the computer system, including an operating system, user application programs, driver and other support files, as well as other data files of all sorts. Typically, the fixed storage 116 serves as the main hard disk for the system.

In basic operation, program logic (including that which implements methodology of the present invention described below) is loaded from the removable storage 115 or fixed storage 116 into the main (RAM) memory 102, for execution by the CPU 101. During operation of the program logic, the system 100 accepts user input from a keyboard 106 and pointing device 108, as well as speech-based input from a voice recognition system (not shown). The keyboard 106 permits selection of application programs, entry of keyboard-based input or data, and selection and manipulation of individual data objects displayed on the screen or display device 105. Likewise, the pointing device 108, such as a mouse, track ball, pen device, or the like, permits selection and manipulation of objects on the display device. In this manner, these input devices support manual user input for any process running on the system.

The computer system 100 displays text and/or graphic images and other data on the display device 105. The video adapter 104, which is interposed between the dis-play 105 and the system's bus, drives the display device 105. The video adapter 104, which includes video memory accessible to the CPU 101, provides circuitry that converts pixel data stored in the video memory to a raster signal suitable for use by a cathode ray tube (CRT) raster or liquid crystal display (LCD) monitor. A hard copy of the displayed information, or other information within the system 100, may be obtained from the printer 107, or other output device. Printer 107 may include, for instance, an HP Laserjet printer (available from Hewlett Packard of Palo Alto, Calif.), for creating hard copy images of output of the system.

The system itself communicates with other devices (e.g., other computers) via the network interface card (NIC) 111 connected to a network (e.g., Ethernet network, Bluetooth wireless network, or the like), and/or modem 112 (e.g., 56 K baud, ISDN, DSL, or cable modem), examples of which are available from 3Com of Santa Clara, Calif. The system 100 may also communicate with local occasionally-connected devices (e.g., serial cable-linked devices) via the communication (COMM) interface 110, which may include a RS-232 serial port, a Universal Serial Bus (USB) interface, or the like. Devices that will be commonly connected locally to the interface 110 include laptop computers, handheld organizers, digital cameras, and the like.

IBM-compatible personal computers and server computers are available from a variety of vendors. Representative vendors include Dell Computers of Round Rock, Tex., Hewlett-Packard of Palo Alto, Calif., and IBM of Armonk, N.Y. Other suitable computers include Apple-compatible computers (e.g., Macintosh), which are available from Apple Computer of Cupertino, Calif., and Sun Solaris workstations, which are available from Sun Microsystems of Mountain View, Calif.

Basic System Software

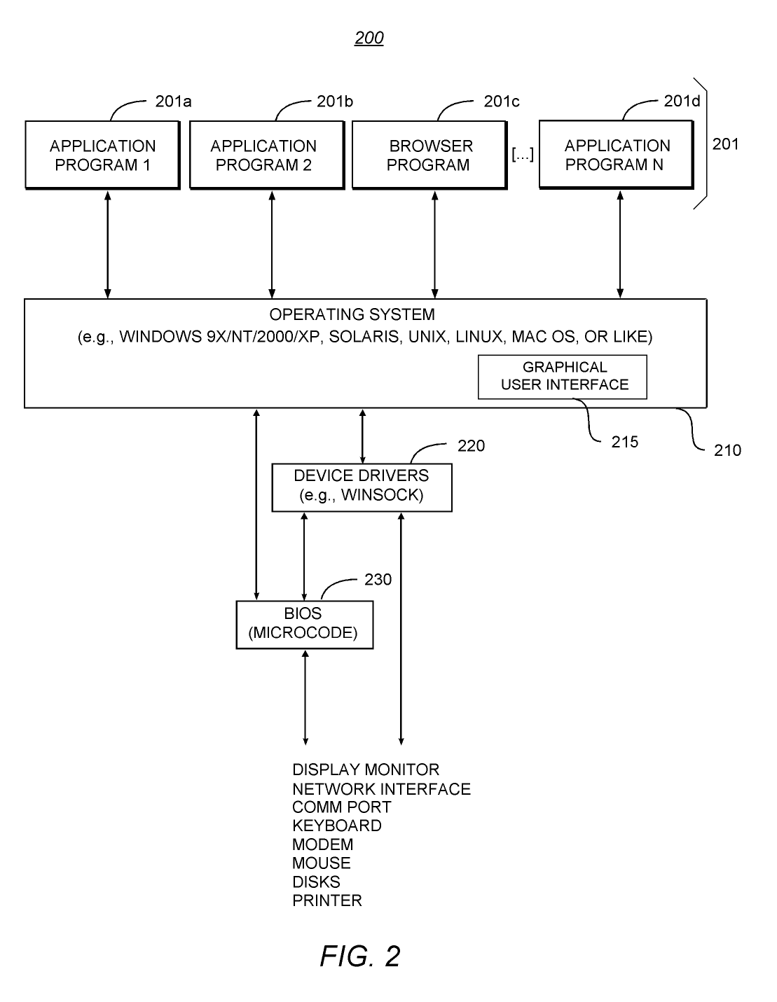

Illustrated in FIG. 2, a computer software system 200 is provided for directing the operation of the computer system 100. Software system 200, which is stored in system memory (RAM) 102 and on fixed storage (e.g., hard disk) 116, includes a kernel or operating system (OS) 210. The OS 210 manages low-level aspects of computer operation, including managing execution of processes, memory allocation, file input and output (I/O), and device I/O. One or more application programs, such as client application software or “programs” 201 (e.g., 201a, 201b, 201c, 201d) may be “loaded” (i.e., transferred from fixed storage 116 into memory 102) for execution by the system 100. The applications or other software intended for use on the computer system 100 may also be stored as a set of downloadable computer-executable instructions, for example, for downloading and installation from an Internet location (e.g., Web server).

Software system 200 includes a graphical user interface (GUI) 215, for receiving user commands and data in a graphical (e.g., “point-and-click”) fashion. These inputs, in turn, may be acted upon by the system 100 in accordance with instructions from the operating system 210, and/or the client application module(s) 201. The GUI 215 also serves to display the results of operation from the OS 210 and application(s) 201, whereupon the user may supply additional inputs or terminate the session. Typically, the OS 210 operates in conjunction with the device drivers 220 (e.g., “Winsock” driver—Windows' implementation of a TCP/IP stack) and the system BIOS microcode 230 (i.e., ROM-based microcode), particularly when interfacing with peripheral devices. OS 210 can be provided by a conventional operating system, such as Microsoft Windows 9×, Microsoft Windows NT, Microsoft Windows 2000, or Microsoft Windows XP, all available from Microsoft Corporation of Redmond, Wash. Alternatively, OS 210 can also be an alternative operating system, such as the previously mentioned operating systems.

The above-described computer hardware and software are presented for purposes of illustrating the basic underlying desktop and server computer components that may be employed for implementing the present invention. For purposes of discussion, the following description will present examples in which it will be assumed that there exists a one or more “server” that communicate with and provide services to one or more “clients” (e.g., desktop computers). The present invention, however, is not limited to any particular environment or device configuration. In particular, a client/server distinction is not necessary to the invention, but is used to provide a framework for discussion. Instead, the present invention may be implemented in any type of system architecture or processing environment capable of supporting the methodologies of the present invention presented in detail below.

Overview of Methodology for Real-Time Control of Server Pools

Demands on data centers

As described above, data centers need to provide real-time responsiveness while also being much more efficient and cost-effective. The demands of real-time business mean that resource allocation has to be aligned with, and driven by, the current business priorities and policies, which may of course be changing over time. Data center operators need to be able to achieve split-second responsiveness to changing priorities and new demands while also guaranteeing service levels at all times and in all conditions in order to ensure that there is no downtime.

In addition to these challenging requirements, data centers also have to be much more cost-effective than in the past. Today, data center managers are typically expected to cut operating costs while improving service at the same time. Many data centers today operate at utilization levels of less than twenty percent (20%). The goal of many data center managers is to increase from these low levels to utilization levels of more than fifty percent (50%), but to do so in a way that also allows service levels to be guaranteed.

Global awareness and ability to react to changes

The present invention provides a mechanism which enables these goals to be simultaneously achieved through a new data center technology that provides almost instantaneous global awareness across the data center as well as nearly instantaneous agility to react to changes. Together these twin elements provide the responsiveness required for both real-time business and peak data center efficiency. The system and methodology of the present invention is fully distributed and thus fully scalable to the largest server pools and data centers. The solution is fault tolerant, with no single point of failure. In order to achieve real-time levels of responsiveness and control, the solution is fully automated and driven by business policies and priorities. The system and methodology of the present invention can also be used with existing server hardware, operating systems, and networks employed in current data center environments.

The solution provides the real-time awareness, automation, and agility required in a data center environment. Guaranteed alignment of computing resources to business priorities requires that every system in the data center be able to respond to changes in resource supply and client demand without relying on a central management tool to adjust the allocations on each server in real-time. This dependency on a centralized intelligence, which is found in earlier performance management systems, has two chief limitations. First, the reliance on a central switch-board makes it difficult, if not impossible, to react quickly enough. Second, the reliance on a centralized intelligence also introduces a single point of failure that can potentially disable the ability to adapt, or worse, could even disable all or part of the data center.

The present invention provides a decentralized system which collects data on the state and health of applications and system resources across the entire pool of servers being managed, as well as the current demand levels and application priorities. A subset of the total information gathered is then distributed to each server in the pool. Each server receives those portions of the collected information which are directly relevant to applications currently being run on that particular server. Each system participates in this global data exchange with its peers, using an extremely efficient bandwidth-conserving protocol.

Following this global information exchange, each server is armed with a “bounded omniscience”—sufficient awareness of the global state of the server pool to make nearly instantaneous decisions locally and optimally about allocation of its own resources in order to satisfy the current needs. As policies and priorities are changed by administrators, or the state of other systems in the pool change, each system gets exactly the data it needs to adjust its own resource allocations.

Once each server in the pool understands the system and network capacity available to it, as well as the needs of each application, it must be able to act automatically and rapidly, rather than relying on overburdened system management staff to take action. Only by this automation can a data center attain the levels of responsiveness required for business policy alignment. Since utilization of one class of resource may affect the data center's ability to deliver a different type of resource to the applications and users requiring them, the system of the present invention provides the ability to examine multiple classes of resources and their interdependencies. For instance, if CPU resources are not available to service a particular need, it may be impossible to meet the network bandwidth requirements of an application, and ultimately, so satisfy the service level requirements of users.

The automated mechanisms provided by the present invention are able to react to both expected and unexpected changes in demand. Unpredictable changes, which manifest as variability in user demand for services based on external events, require almost instantaneous adjustment under existing policies. Predictable changes, such as dedicating resources for end-of-period closing and reporting activities, require integration with a scheduling function that can adjust the policies and priorities themselves.

The real-time data center needs to combine its automation and awareness with new levels of agility. Response to changing demand must be very rapid and fine-grained. For instance, rather than just adjusting priority and counting on built-in scheduling algorithms to approximate the needed CPU allocations correctly, the system and methodology of the present invention provides more advanced local operating system techniques such as share-based allocation to provide more goal oriented tuning.

No matter how exact current local management mechanisms may be, they are still limited by their single-system nature; changes in load or resource availability on other servers in the pool will not affect how a given server performs allocations. Effective global resource management requires the ability to use those finer-grained, more results oriented knobs and a global awareness to inform and adjust each server.

Enforcement of business policies and priorities

In order to guarantee that applications can be given the resources they need to satisfy business policies and priorities, the present invention makes it possible not only to burst additional resources to applications when required, but also to constrain their use by other applications. This prevents rogue applications or resource-hungry low-priority users from sapping the computing power required by business-critical applications.

The system and methodology of the present invention controls the continuous distribution of resources to applications across a pool of servers, based on business priorities and service level requirements. It unifies and simplifies the diverse and constantly changing hardware elements in a data center, allowing the incremental removal of silo boundaries within the data center and the pooling of server resources. The solution provides real-time awareness, agility and automation. Dynamic resource barriers provide split-second policy-driven bursting and containment, based on global awareness of the data center state. With this capability, the total computing power in the data center becomes extremely fluid and can be harnessed in a unified way by applications on demand.

Data Center Environment

Before describing the components of the present invention and their operations in more detail, it is helpful to define current data center environments and the requirements placed upon them. A data center environment includes both resource suppliers and resource consumers. The user's view of how computing resources are monitored and managed (e.g., by the system of the present invention), and how these resources are consumed, is hierarchical in nature. Computing resources are supplied (or “virtualized”) by server pools. A server pool is a collection of one or more servers and a collection of one or more “pipes”. A server is a physical machine which supplies CPU and memory resources. A “pipe” is a shared network path for network traffic (e.g., Internet Protocol traffic) which supplies inbound and outbound network bandwidth. A server pool aggregates the resources supplied by the servers. Pipes are shared by all servers in the server pool.

Computing resources are consumed by one or more programs (e.g., application programs) which run in the server pool. A program or application is comprised of one or more instances and/or one or more “flows”, and consumes the resources of a server pool. An application instance is a part of an application running on a single server which consumes the resources of that server. A “flow” is a subset of network traffic which usually corresponds to a stream (e.g., Transmission Control Protocol/Internet Protocol or TCP/IP), connectionless traffic (User Datagram Protocol/Internet Protocol or UDP/IP), or a group of such connections or patterns identified over time. A flow consumes the resources of one or more pipes.

An application resource usage policy (or “resource policy”) is a specification of the resources which are to be delivered to particular applications. The system of the present invention generally provides for a resource policy applicable to a particular application to be defined in one of two ways: the first is based on a proportion of the server pool's total resources, namely, pipes and aggregated server resources; the second is based on a proportion of the pipes and individual server resources used by the application(s). In either case, the proportion of a resource allocated to a given application can be specified either as an absolute value, in the appropriate units of the resource, or as a percentage relative to the current availability of the appropriate resource.

The “headroom” or “burst capacity” of an application is a measure of the extra resources (i.e., resources beyond those specified in the application's policy) that may potentially be available to it should the extra resources be idle. The headroom of an application is a good indication of how well it may be able to cope with sudden spikes in demand. For example, an application running on a single server whose policy guarantees it 80% CPU, has 20% head-room. However, a similar application running on two servers whose policy is 40% of each CPU has headroom of 120% (i.e., 2×60%).

System Functionality

The present invention provides a distributed and symmetric system, with component(s) of the system running on each server in the server pool that is to be controlled. The system is, therefore, resilient to hardware failures. The fully distributed nature of the design also means that there is no centralized component that limits scalability, enabling the system to achieve real-time sub-second level responsiveness and control on even the largest data centers, with no single point of failure.

In its currently preferred embodiment, the system provides the core functionality described below:

Distributed Instantaneous Global Awareness. Distributed, low-overhead, high performance global information exchange between servers for the automatic real-time checkpointing and maintenance of a consistent global state across server pools and data centers.

Software Resource Barriers. Service level agreements and policy priorities for dynamic data center applications are guaranteed by the use of automatically adjustable software resource barriers, rather than by having dedicated physical servers and networks.

Automatic Bursting and Containment. Almost instantaneous policy-based bursting and containment of shared resources is provided in a distributed computing environment, allowing real-time agility in resource allocation and optimal dynamic allocation of shared bandwidth.

Distributed Global Resource Balancing. Automatic, self-adaptive resource balancing across data center applications and application instances, which is independent of load balancing, and instead moves resources in response to changes in traffic load in real-time.

Distributed Internal Data Store. A system for the real-time distribution and local application of resource control policies and the recording of historical resource utilization data. The system is fully distributed, self-replicating, fault tolerant and highly scalable.

Application Discovery. Automatic rule-based discovery of applications and their resource components.

Business Policy Engineering. Automatic improvement of sets of policies and service level agreements for data center resource allocation based on the continuous analysis and transformation of historical data, signature-driven optimization algorithms, and an accurate data center model.

Application-Specific Policy-Based Management of Resources

Operational Phases

The user achieves application resource optimization by using the policy enforcement capability of the system of the present invention to ensure that each application in the server pool receives the share of resources that is specified by the user in the resource policy. In this way, multiple applications are able to execute across servers with varying priorities. As a result, otherwise idle capacity of the server pool is distributed between the applications and overall utilization increases.

The use of the system and methodology of the present invention typically proceeds in two conceptual phases. During the first phase, the mechanism's policy enforcement is inactive, but the user is provided with detailed monitoring data that elucidates the resource consumption by the applications in the server pool. At the end of this phase, the user has a clear view of the resource requirements of each application based on its actual usage. During this phase, the system of the present invention also assists the user in establishing a resource policy for each application. The second phase activates the enforcement of the application resource policies created by the user. The user can then continue to refine policies based on the ongoing monitoring of each application by the system of the present invention.

Monitoring Server Pools

The system of the present invention is usually deployed on a server pool with policy enforcement initially turned off (i.e., deactivated). During the first phase of operations, the goals are to determine the overall utilization of each server's CPU, memory, and bandwidth resources over various periods of time. This includes determining which applications are running on the servers and examining the resource utilization of each of these applications over time. Application detection rules are used to organize processes into application instances, and instances into applications. The system also suggests which application instances should be grouped into an application for reporting purposes. The user may also conduct “what-if” predictive situations to visualize how applications might be consolidated without actually performing any application re-architecture. The aggregated utilization information also allows system to generate an initial suggested resource policy for an application based on data regarding its actual usage of resources.

To support these high level goals, the system of the present invention gathers a number of items of information about the operations of a data center (server pool). The collected data includes detailed information about the capacity of each monitored server. The information collected about each server generally includes its number of processors, memory, bandwidth, configured Internet Protocol (IP) addresses, and flow connections made to the server. Also, within each server pool, the system displays per-server resource utilization summaries to indicate which servers are candidates for supporting more (or less) workload.

The system also generates an inventory of all running applications across the servers. A list of all applications, running on all servers, is displayed to the user. Processes that can be automatically organized into an application by the system are so organized for display to the user. Not all applications identified by the system will be of immediate interest (e.g., system daemons), and the system includes a facility to display only those applications specified by the user.

The resources consumed by each running program (e.g., application) are also tracked. In its currently preferred embodiment, the system displays a summary of the historical resource usage by programs over the past hour, day, week, or other period selected by the user. Historical information is used given that information about current, instantaneous resource usage is likely to be less relevant to the user. The information that is provided can be used to assess the actual demands placed on applications and servers. Another important metric shown is the number of connections serviced by an application.

After the above information is collected, the system is then able to allow “what-if” situations to be visualized. Increased resource utilization in a server pool will be observed once multiple applications are executed on each server to take advantage of previously unused (or spare) capacity. Therefore, the system allows the user to view various “what-if” situations to help organize the way applications should be mapped to servers, based on their historical data. For example, the system identifies applications with complementary resource requirements that are amenable to execution on the same set of servers. Additionally, the applications that may not benefit from consolidation are identified. Particular applications may not benefit from consolidation as a result of factors particular to such application. For example, an application with erratic resource requirements over time may not benefit from consolidation.

The system also includes intelligence to suggest policies for each application based on its recorded use. Generally, the system of the present invention displays a breakdown of the suggested proportion of resources that should be allocated to each application, based on its actual use over some period. Of course, the user may wish to modify the historical usage patterns, as the business priorities may not be currently reflected in the actual operation of the data center. Accordingly, displaying the currently observed apportionment of resources is a starting point for the user to apply their business priorities by editing the suggested policies.

Policy Enforcement

The policy enforcement mechanisms of the present invention can be explicitly turned on (i.e., activated) by the user at any stage. The objectives of enforcing policies, from the user's perspective, are to constrain the resource usage of each program (e.g., application) to that specified in its policy, and to facilitate a verifiable increase in overall resource utilization over time. Currently, applications that are not subject to a policy typically are provided with an equal share of the remaining resources in the server pool.

Although achieving better resource utilization frequently requires migrating multiple applications onto each server, users typically preserve the same application architecture that was in effect before activation of policy enforcement until they become comfortable with the system. Therefore, once policy enforcement has been activated, the system continues to monitor the server pool resource utilization and allow the user to iteratively verify that resource policies are being enforced as well as to adjust the resource policy based upon changing circumstances and priorities.

Verifying that policies are being enforced includes generating reports to demonstrate that application policies are being delivered. The reports constitute charts that show:

the amount of resources reserved in the policy; the amount of resources actually consumed by the application; and the reasons why an application may have used fewer resources than those specified in its policy (e.g., limited demand for the application, or a small number of connections). Based on the information provided, the user may elect to adjust the policy from time to time. For example, the user may adjust the policy applicable to those applications which are reported to be over-utilized or under-utilized, in order to tune (or optimize) the distribution of server pool resources between the applications.

User Interface

As described above, the first phase of operations typically involves reporting on the ongoing consumption of computing resources in a server pool. This reporting on resource consumption is generally broken down by server, application, and application instances for display to the user in the system user interface.

Processes are organized into application instances and applications by a set of detection rules stored by the system, or grouped manually by the user. In the currently preferred embodiment, an XML based rule scheme is employed which allows a user to instruct the system to detect particular applications. The XML based rule system is automated and configurable and may optionally be used to associate a resource policy with an application. Default rules are included with the system and the user may also create his or her own custom rules. The user interface allows these rules to be created and edited, and guides the user with the syntax of the rules. A standard “filter” style of constructing rules is used, similar in style to electronic mail filter rules. The user interface allows the user to select a number of application instances and manually arrange them into an application. The user can explicitly execute any of the application detection rules stored by the mechanism.

As part of this process, a set of application detection rules are used to specify the operating system processes and the network traffic that belong to a given application. These application detection rules include both “process rules” and “flow rules”. As described below, “process rules” specify the operating system processes that are associated with a given application. “Flow rules” identify network traffic belonging to a given application. All components of an application are managed and have their resource utilization monitored as a single entity, with per application instance breakdowns available for most areas of functionality.

Each process rule specifies that the operating system processes with a certain process name, process ID, user ID, group ID, session ID, command line, environment variable(s), parent process name, parent process ID, parent user ID, parent group ID, and/or parent session ID belong to a particular application (or job). Optionally, a user may declare that all child processes of a given process belong to the same task or job. For example, the following process rules indicate that child processes are defined to be part of a particular job (application):

| | |
|---|---|
| 1: | ... |
| 2: | <JOB-DEFINITION> |

| | |
|---|---|
| 3: | <PROCESS-RULES INCLUDE-CHILD-PROCESSES=“YES” |
| > | |

| | |
|---|---|
| 4: | <PROCESS-RULE> |

| | |
|---|---|
| 5: | <PROCESS-NAME>httpd</PROCESS-NAME> |

| | |
|---|---|
| 6: | </PROCESS-RULE> |
| 7: | ... |

| | |
|---|---|
| 8: | </PROCESS-RULES> |
| 9: | ... |
| 10: | </JOB-DEFINITION> |

Similarly, each flow rule specifies that the network traffic associated with a certain local IP address/mask and/or a local port belongs to a particular application. For example, the following flow rule specifies that traffic to local port 80 belongs to a given application:

| | |
|---|---|
| 1: | <JOB-DEFINITION> |

| | |
|---|---|
| 2: | ... |
| 3: | <FLOW-RULES> |

| | |
|---|---|
| 4: | <FLOW-RULE> |

| | |
|---|---|
| 5: | <LOCAL-PORT>80</LOCAL-PORT> |

| | |
|---|---|
| 6: | </FLOW-RULE> |
| 7: | ... |

| | |
|---|---|
| 8: | </FLOW-RULES> |

| | |
|---|---|
| 9: | </JOB-DEFINITION> |

| | |
|---|---|
| 10: | ... |

In the presently preferred embodiment of the system, the application detection rules are described in an XML document. Default rules are included with the system and a user can easily create custom rules defining the dynamic actions that should automatically be triggered when certain conditions are applicable to the various applications and servers within the server pool (i.e., the data center). The system user interface enables a user to create and edit these application detection rules. An example of an XML detection rule that may be created is as follows:

| | |
|---|---|
| 1: | <APP-RULE NAME=“AppDaemons” FLAGS=“INCLUDE-C |

HILD-PROCESSES”>

| | |
|---|---|
| 2: | <PROCESS-RULE> |

| | |
|---|---|
| 3: | <PROCESS-VALIDATION-CLAUSES> |

| | |
|---|---|
| 4: | <CMDLINE>appd*</CMDLINE> |

| | |
|---|---|
| 5: | </PROCESS-VALIDATION-CLAUSES> |

| | |
|---|---|
| 6: | </PROCESS-RULE> |
| 7: | <FLOW-RULE> |

| | |
|---|---|
| 8: | <FLOW-VALIDATION-CLAUSES> |

| | |
|---|---|
| 9: | <LOCAL-PORT>3723</LOCAL-PORT> |
| 10: | </FLOW-VALIDATION-CLAUSES> |

| | |
|---|---|
| 11: | </FLOW-RULE> |

| | |
|---|---|
| 12: | <POLICY> |
| 13: | ... |
| 14: | </POLICY> |
| 15: | </APP-RULE> |

As illustrated above, the application detection rule for a given application includes both process rule(s) and flow rule(s). This enables the system to detect and associate CPU usage and bandwidth usage with a given application.

The system automatically detects and creates an inventory of all running applications in the data center (i.e., across a cluster of servers), based on the defined application detection rules. The application detection rule set may be edited by a user from time to time, which allows the user to dynamically alter the way processes are organized into applications. The system can then present resource utilization to a user on a per application basis as will now be described.

Monitoring Server Pools

The consumption of the aggregated CPU and memory and resources of a server pool by each application or application instance is monitored and recorded over time. In the currently preferred embodiment of the system, the information that is tracked and recorded includes the consumption of resources by each application; usage of bandwidth (“pipe's in and out”) by each application instance; and usage of a server's resources by each application instance. The proportion of resources consumed can be displayed in either relative or absolute terms with respect to the total supply of resources.

In addition, the system can also display the total amount of resources supplied by each pool, server, and pipe to all its consumers of the appropriate kind over a period of time. In other words the system monitors the total supply of a server pool's aggregated CPU and memory resources; the server pool's “pipe's in and out” bandwidth resources; and the CPU and memory resources of individual servers.

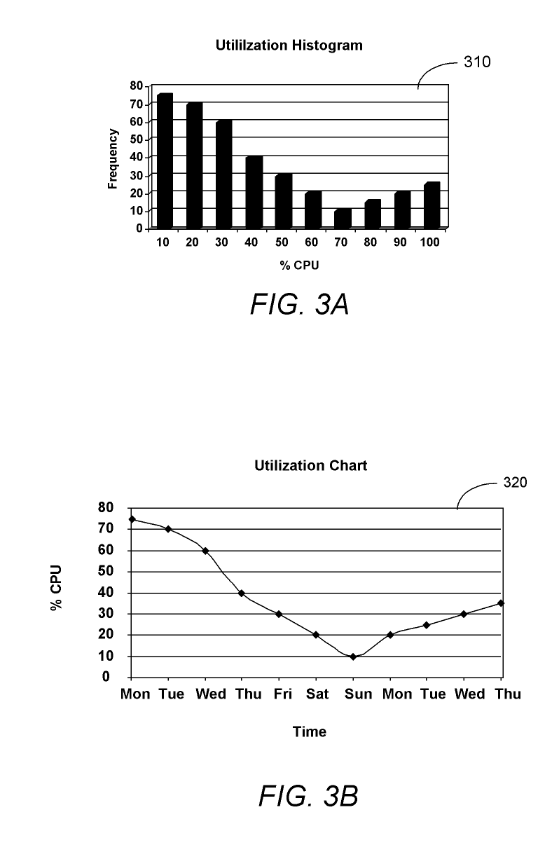

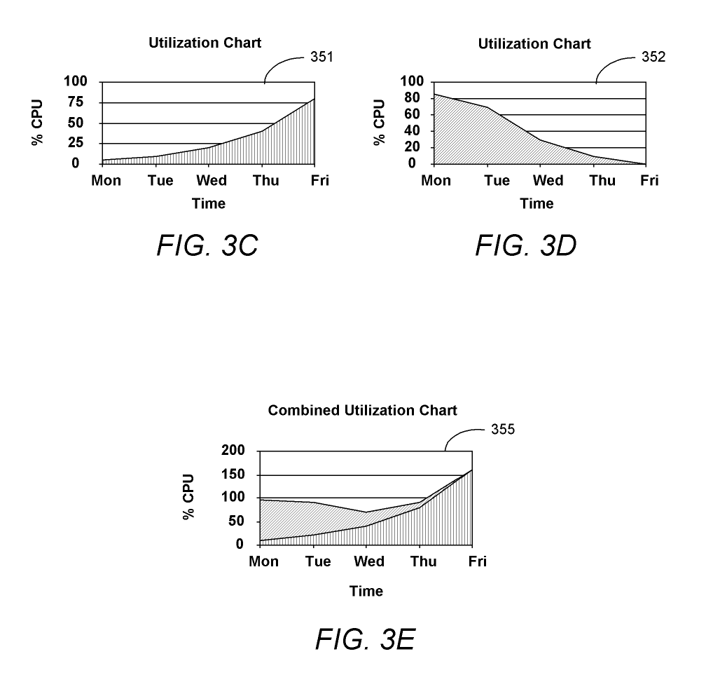

A further resource monitoring tool provided in the currently preferred embodiment is a “utilization summary” for a resource supplier and consumer. The utilization summary can be used to show its average level of resource utilization over a specified period of time selected by the user (e.g., over the past hour, day, week, month, quarter, or year). For example, for each server pool, server, pipe, application, and instance, during a set period, the user interface can display the average resource utilization expressed as a percentage of the total available resources. The utilization summary for a resource can be normalized to an appropriate base, so that similar hierarchy members can be directly compared (e.g., the user can compare the CPU utilization summaries of all the servers in a pool simultaneously in a pie-chart view). Such a view allows the user to easily determine the varying degrees of resource usage for pools, servers, applications, and instances. The user interface can total and compare, in a single view, the utilization summaries for all selected server pools, servers, pipes, applications, or instances. For example, a user may wish to review the CPU utilization of a particular application. FIG. 3A is a utilization histogram 310 illustrating how the CPU utilization of a particular application was distributed over time. As shown, the utilization histogram 310 provides fine grain analysis of a utilization summary by breaking it down into a plot of the number of times a certain utilization percentage was reached by the resource over the time period.

FIG. 3B is a utilization chart 320 illustrating the percentage of CPU resources used by an application on a daily basis over a period of time. For each server pool, server, application, and instance, during a set period, a graph of the actual resource utilization over time may be displayed in the user interface. The system also analyzes the periods during which an application used more (or less) resources than a threshold specified by the user. In the presently preferred embodiment, the user interface highlights time durations, along with the actual usages, during which the resources of a utilization chart were more or less than a value specified by the user. The headroom of an application that runs on multiple servers is also illustrated by charting the actual utilization against a scale, where the maximum value on the axis is the aggregated total of the resource. The user interface displays the headroom of an application with respect to its current mapping to resources.

“What-if” Scenarios

By manipulating the monitoring data in the manner described above, the user has the opportunity to carry out “what-if” scenario exploration to help guide the placement of applications in a server pool and to predict the effects of making particular changes to the allocation of resources. More particularly, the system's graphical user interface includes a mode of operation that provides the user with tools to conduct “what-if” scenarios. Utilization charts are vital to help plan for a consolidation; for example, the mechanism can interpret the utilization chart for each application and identify applications having complementary resource requirements over their life which may be appropriate for execution on the same set of servers. Moreover, a user may which to conduct “what-if” scenarios by superimposing several applications' utilization charts to see how their resource utilization would look if they were executed on the same set of resources.

The user interface can combine the utilization charts for selected applications over a set period by constructing a new chart that totals their resource usage over their coincident time spans, and displays each chart stacked on top of one another. Applications that exhibit peaks in demand at different times or those that require, on average, only a fraction of the resources available on a server may be ideal candidates for migration to the same set of servers, and combining utilization charts assists users in making appropriate decisions before the applications are actually run together on the same server or set of resources.

FIG. 3C is a utilization chart 351 for a first application over a certain period of time. FIG. 3D is a utilization chart 352 for a second application over the same period of time. FIG. 3E is a combined utilization chart 355 illustrating the combination of the two applications shown at FIGS. 3C-D on the same set of resources. As shown, combining the utilization charts for the two applications enables the user to envisage how the two applications might interact if they shared the same set of resources. Combining the charts involves “summing” their resource use over the time period, with the desired outcome displayed as a new chart with higher average utilization than its constituent charts. The resultant resource utilization of combined charts should ideally remain below the maximum available for the shared resources; otherwise insufficient resources may be available to execute the applications together on the same resources. However, depending on the nature of the applications being combined, it may be possible to amortize any periods of over-utilization across a longer time period, resulting in a successful consolidation.

Activating Policy Enforcement

The system controls the consumption of a server pool's aggregated resources by enforcing a resource policy that specifies the resources to be allocated to each application or application instance. The aggregated resources that are regulated include the CPU resources of one or more servers as well as a “pipe's in and out” bandwidth. An application's resource policy can be met by supplying different levels of resources from each server rather than providing equal contributions from each shared resource. Another purpose of policy enforcement is to suggest and tailor policies for applications that are selected by the user, and then continue to monitor how well applications behave in order to fine tune these policies on an ongoing basis.

The system can also be extended to control other local resources, such as memory and Input/Output bandwidth. The proportion of a resource to be provided to a given application under a resource policy can be specified either as an absolute value (in the appropriate units) or as a percentage value relative to the current availability of the appropriate resource. A policy for an application generally has at least the following attributes: an unending duration (i.e., continuing until modified or terminated); the proportion of resources the application is entitled to use; and the virtual Internet Protocol addresses and ports that should be configured for the application.

The utilization analysis previously described determines the utilization summary and other statistical information about the actual resource needs of an application. From this data, the system can infer (and suggest to the user) an initial policy for any application. Of course, an initial policy may not quite reflect the business priorities of an application, and the user can edit the suggested initial policy to reflect better the importance of the application to the user. For example, an initial policy for any application may be suggested based on actual observed usage of resources by the application over some period of time. The suggested application (resource) policy is displayed in the user interface. The user may dynamically modify the policy and enable the policy for enforcement. More particularly, the user interface of the currently preferred embodiment allows a user to issue an explicit command to activate or deactivate policy enforcement from time to time. When policy enforcement is activated, all policies enabled by the user are automatically enforced.

For example, the system can automatically check to verify that the resource policy desired by the user is being applied in a particular instance. This is illustrated by the following routine:

| | |
|---|---|
| 1: | <JOB-TRIGGER> |

| | |
|---|---|
| 2: | <TRIGGER-CONDITION CHECK=“ON-TIMER”> |

| | |
|---|---|
| 3: | NE(PercCpuSlaPool, PercCpuReqSlaPool) |

| | |
|---|---|
| 4: | </TRIGGER-CONDITION> |
| 5: | <TRIGGER-ACTION WHEN=“ON-TRUE”> |

| | |
|---|---|
| 6: | <TRIGGER-SLA TYPE=“SET”> |

| | |
|---|---|
| 7: | <SLA-RULE RESOURCE=“CPU”> |

| 8: | <SLA-POOL-VALUE |
|---|---|
| | TYPE=“ABSOLUTE” RANGE=“RE |
| QUESTED”> | |
| 9: | PercCpuReqSlaPool |
| 10: | </SLA-POOL-VALUE> |

| | |
|---|---|
| 11: | </SLA-RULE> |

| | |
|---|---|
| 12: | </TRIGGER-SLA> |

| | |
|---|---|
| 13: | </TRIGGER-ACTION> |

| | |
|---|---|
| 14: | </JOB-TRIGGER> |

The above routine periodically checks to determine if the desired resource policy (“SLA”) on a server is the same as the requested policy (SLA) in effect. The desired policy and the requested policy may differ if, for example, a rule attempts to set a particular allocation of resources, but the setting failed as a result of insufficient resources. The above routine ensures that the desired resource policy is periodically reapplied, if necessary. In its presently preferred embodiment, the system automatically performs this check in the event that insufficient resources were available to allocate the resources as desired (i.e., based upon the desired resource policy) at the time at which the policy was enforced.

Once policy enforcement is activated, the user is able to verify that the policy put in place for an application is being enforced. In particular, for an application that has a policy, the user interface is able to compare the application's resource utilization to the resource levels specified in the policy; the user can then see the periods of time during which the application received more (or less) of a resource than specified in its policy. From this, the user can determine (a) the proportion of time that an application was “squeezed” for resources—in which case it may require more resources allocated to it, or (b) the time that the application was “idle”—in which case the user may revise the resource policy to provide for the application to relinquish some of its resources.

Server Pool, Server, Application, and Application Instance Inventory

The various means by which the user interface of the currently preferred embodiment reports the resources consumed by the members of the server pool hierarchy have been previously described. The following provides additional details about the hierarchy elements that are presented to the user to help administer a server pool.

For each server pool, and for as long as the historical data is available, the currently preferred user interface displays the server pool's utilization summary, its utilization histograms, the servers in the pool, and the programs (applications) running in the pool. The user interface displays, for each server: its utilization summary; its utilization histograms; the application instances running on the server; and pertinent physical configuration details including any reported failures.

The user interface also displays, for each application: its utilization summary; its utilization histograms; the servers on which it runs; its resource policy (if applicable); a reference to the detection rule that created the application; and pertinent physical details. In addition, the user interface displays, for each application instance: its utilization summary; its utilization histograms; its running processes and active flows; and pertinent physical details.

A user may select multiple similar entities in the graphical user interface of the system to combine similar attributes as appropriate. For pools, servers, and applications, it generally is appropriate to compare their important aspects simultaneously. The user interface displays in a comparative view: for each server pool, detailed information about each application running on the pool; and, for each server, detailed information about each application instance running on the server. Some of the operations that are performed by server components of the present invention that are deployed on each server in the server pool to be managed will now be described.

Server Monitoring and Management

Monitoring Server Pools

The system periodically generates application usage reports and documents periods of policy breach, or periods of downtime in the event of catastrophic failures, and also demonstrates the periods over which policies were met. Every day, week, month, quarter, or year, administrators may be required to generate reports for customers or internal business groups. These reports typically document application resource consumption over that period and are used for capacity planning and/or charge back. One aim of the system of the present invention is to reduce the numbers of servers and/or the degree of manual administration required, while maintaining an optimal level of application service and availability. One compelling way to demonstrate this value, in terms of resource usage, is to show the overall utilization of the pool's resources over a user-specified period of time. For example, the resource utilization of the system after implementation of a resource policy may be compared to the initial resource utilization data recorded when the system was in a monitoring-only mode.

The system allows an authorized user to delete selected historical data from the system's data store. Historical data can be exported to third-party storage systems, and subsequently imported back into the system as required, such that the historical data may be accessed by the system at any time. The system allows historical data to be exported to standard relational database systems. The system also monitors various events that occur in the server and communicates these events to the user interface and to third-party management dashboards. This mechanism allows the user to receive notice from the server components of the system of events that may be of interest.

Application Management

Policy enforcement isolates the operation of one application from another according to the resource allocations specified in their respective policies. Insufficient application isolation could significantly harm the implementation of the customer's intended business priorities. The system provides for isolation of the resource consumption of different applications running on the same server. This isolation ensures that each application's policy is not compromised by the operation of another application.

In order to increase application headroom while simultaneously improving server utilization, a customer may consider running multiple copies of an application on multiple servers. To accommodate customer environments that do not already have load-balancing capabilities, the system provides a load balancing facility to forward requests between application instances. This load balancing facility randomly load balances traffic from different Internet Protocol addresses between the instances of an application, if desired by the user, such that any session-stickiness requirements of the application are respected. The session-stickiness of an application is respected by avoiding sending traffic from the same Internet Protocol address to a different server within a configurable period of time.

Adding and Removing Servers

The system is designed to run on arbitrarily large numbers of servers, with the proviso that all architectural requirements (like network topology) are met that would otherwise preclude execution on a larger number of servers. As soon as an instance of the system of the present invention starts operating on a single server it begins monitoring the resources used by the application instances running on that server; further servers may be added to the server pool at any time. The monitoring functionality of the system is independent of the static configuration of maximum server pool size, quorum, or topology. The system permits incremental growth from a single server to a large pool of servers by repeatedly adding a single new system to an existing server pool. The same is true for contraction in size of the server pool.

Monitoring Servers and Applications

As previously described, the system has two distinct conceptual modes of operation: monitoring and policy enforcement. When policy enforcement is off (i.e., inactive), the system collects detailed monitoring data about all running applications. Once components of the system of the present invention are loaded on a server, the monitoring of the server and its applications occurs immediately. During periods of high load on a server pool, the application resource usage statistics are recorded at more frequent intervals. The components of the system are designed in such a way that they do not themselves consume any significant server pool resources during these periods, which could otherwise have an adverse effect on the performance of the server pool. While the resources required by the system depend to some extent on the number of servers in the pool and on the number of aplications and flows being managed, the system does not consume more than a small, bounded fraction of the server pool resources. On server pools with up to 128 servers, testing indicates that the system consumes no more than the following resources of a single server, averaged over a period of 60 seconds, at any time: 2% of CPU; 2% of bandwidth, and 25Mb of RAM (assuming no command line interface or graphical user interface requests are being processed).

Similarly, the user may conduct many “what-if” scenarios which require potentially significant amounts of data to be extracted from the system's data store. In such situations, it may not be possible to ensure a time to complete an operation since the amount of data requested may be variable. However, in these situations the system provides feedback to the user of the required time to complete the operation, in the form of a progress bar. This feedback mechanism provides the user with an ongoing estimate of how long it will take to complete a particular operation if it cannot be completed within 5 seconds. The actual time taken to complete an operation is generally within 25% of the original estimate. Experience also indicates that on server pools with up to 128 servers, all active command line interface and graphical user interface operations will not themselves consume, or cause the mechanism to consume, more than the following resources on any server, unless spare resources are available: 5% of CPU; 5% of bandwidth; and 25Mb of RAM.

Policy Enforcement

The system's dynamic nature offers a user unique functionality such as vertical bursting and horizontal morphing of applications, neither of which are possible when utilizing static resource partitions. Policy enforcement may be activated almost instantaneously. Testing indicates that the activation of policy enforcement takes no longer than 5 seconds for all servers in the pool on server pools with up to 128 servers. To provide dynamic control of applications, it is desirable that a change to a policy is instituted as quickly as possible, no matter how great the load on the server pool. The system of the present invention enables a policy to be applied to an application within 5 seconds on server pools with up to 128 servers.

High Availability and Fault Tolerance

Servers, networks, and applications may fail at any time in a server pool and the system should be aware of these failures, whenever possible. During a failure, the system does not necessarily attempt to recover or restart applications, unless instructed to do so by conditions in an application's resource policy. The system does continue to manage all applications that remain after the failure. Generally, the system continues to operate with a suitably scaled policy with respect to the remaining resources. A mechanism is available to report failures to the user by passively logging messages to the system log. The system continuously monitors its health and can automatically restart any of its daemons that fail. The user is notified immediately of the failure, and also of whether the restart restored correct operation.

Servers and other resources in a data center may experience failures from time to time. In the event one or more servers fail or resources are otherwise unavailable, it may become impossible to provide each of the applications with the absolute levels of resources defined in their policies. After any failure that affects the supply of resources, the system of the present invention will automatically preserve the priorities of each application policy relative to the remaining resources, unless another policy is specified by the user. By default, the system of the present invention attempts to preserve resource levels in priority relative to the absolute application policies. The system also allows new policies to be set for applications when resources change. A feature which enables a user to specify conditions under which applicable resource policies should automatically change policies is part of the functionality provided by the system. The components of the system of the present invention providing the core functionality of performance isolation and resource level guarantees to programs (e.g., application programs) running on a large pool of servers will next be described.

System Components and Architecture

General

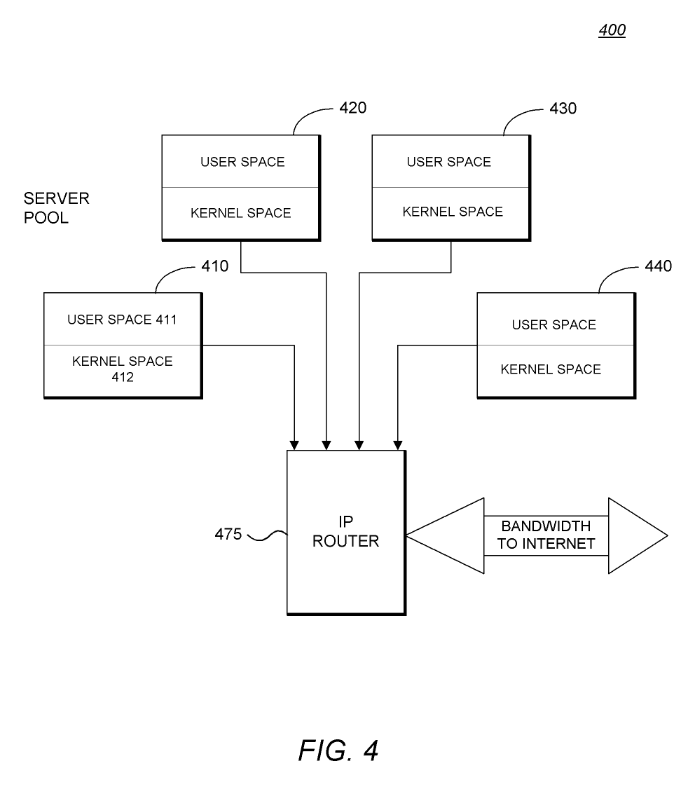

The system of the present invention, in its currently preferred embodiment, is a fully distributed software system that resides on each server in the pool that it manages, and has no single point of failure. FIG. 4 is a block diagram of a typical server pool environment 400 in which several servers are interconnected via one or more switches or routers. As shown, four servers 410, 420, 430, 440 are connected via an IP router 475 providing internal and external connectivity. The fours servers 410, 420, 430, 440 together comprise a networked server pool. Each server in the pool of networked servers can be running different operating systems. Each server also has both a user space and a kernel space. For example, server 410 includes a user space 411 and a kernel space 412, as shown at FIG. 4. The system of the present invention executes software components in both the operating system kernel (or kernel space) and in the user space of each server. The system monitors the resources used by all applications running in the server pool and allows the user to specify resource policies for any number of them. The system also provides a mechanism for enforcing resource policies which ensures that only the quantity of resources listed in the policy are delivered to the application whenever there is contention for resources.

Components of the system execute on each server in the cooperating pool of servers (e.g., on servers 410, 420, 430, 440 at FIG. 4). Because components are installed on each server, the system is able to provide a brokerage function between resources and application demands by monitoring the available resources and matching them to the application resource demands. It can then apply the aggregated knowledge of these values to permit the system to allocate the resources for each application specified by its policy, even during times of excessive demand.

One main function of the system is to prioritize the allocation of computing resources to applications running in the server pool based upon a resource policy. A resource policy comprises the proportion of the available resources (e.g., CPU and bandwidth resources) that should be available to a particular program at all times when it needs resources. The system is controlled and configured by a user via a graphical user interface (GUI), which can connect remotely to any of the servers, or a command line interface, which can be executed on any of the servers in the pool. The architecture of the system in both the operating system kernel and in the user space will now be described in greater detail.

Kernel Space Architecture

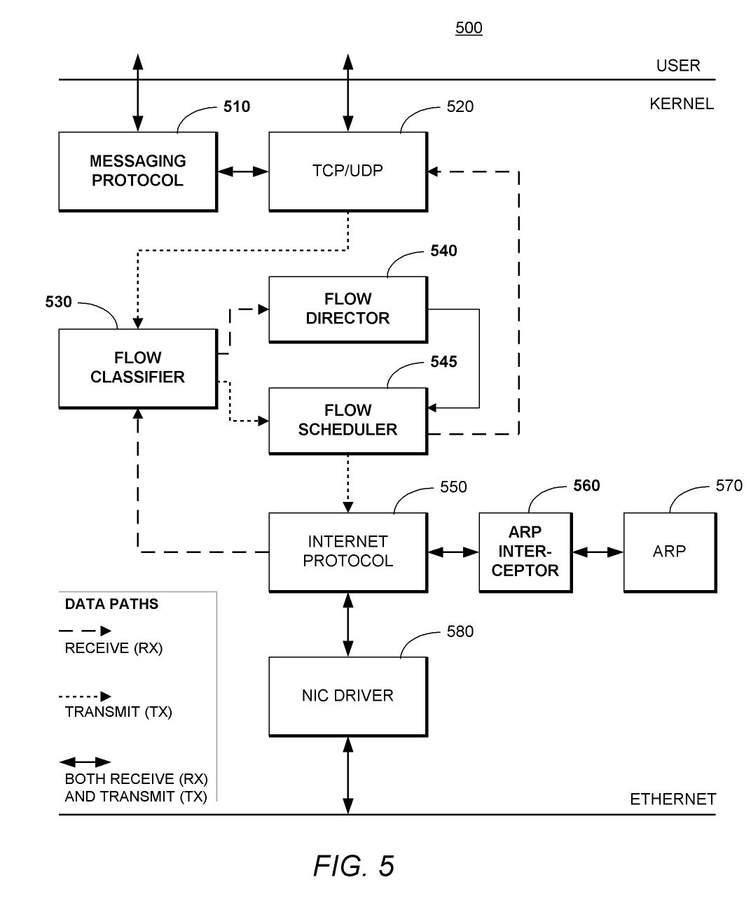

On each server, the kernel components of the system of the present invention monitor network traffic to and from applications, and enforce the network component of a resource policy. FIG. 5 is a block diagram 500 illustrating the interaction between the system's kernel modules and certain existing operating system components. The system's kernel modules are illustrated in bold print at FIG. 5. As shown, the system's kernel modules include a messaging protocol 510, a flow classifier 530, a flow director 540, a flow scheduler 545, and an ARP interceptor 560. Operating system components shown at FIG. 5 include a TCP/UDP 520, an Internet protocol stack 550, an ARP 570, and an NIC Driver 580.

The arrows shown at FIG. 5 illustrate the flow of packets being transmitted to, or received from, an Ethernet network through the various system components. The data paths are shown by dashed lines, dotted lines, and solid lines as follows: a dashed line indicates a path for receive packets; a dotted line indicates a path for transmit packets; and a solid line indicates a path for both transmit and receive packets.

The messaging protocol 510 provides a documented application programming interface for reliable and scalable point-to-point communication between servers in the pool. The protocol is implemented on top of the standard User Datagram Protocol (UDP). The protocol is exclusively used by the distributed components of the system's daemons to enable the system of the present invention to efficiently scale up to very large pools of servers.

The flow classifier 530 organizes Internet Protocol (e.g., Internet Protocol version 4) network traffic into “flows”. A flow is a collection of Internet Protocol connections or transmissions that are identified and controlled by the system. The flow classifier generates resource accounting events for each flow. These resource accounting events are received and stored by other components of the system. The flow classifier is the first component of the system to receive incoming and outgoing network traffic from all applications on the server.

The flow scheduler 545 prioritizes the transmission and receipt of data packets to and from programs (e.g., applications). If a small amount of traffic passes through the flow scheduler, then it is immediately passed through to the Internet Protocol stack 550. Consequently, in an environment where communication traffic is light, the system is able to monitor bandwidth usage without affecting the latency of transmission. However, if a significant amount of data begins to pass through the flow scheduler then the data may be delayed and transmitted according to a policy (i.e., a resource policy established by a user) that covers the flow to which the traffic belongs. Therefore, when bandwidth resources are limited, the consumption of these resources is governed by the resource policies that are defined.

The flow scheduler 545 is a distributed component which communicates its instantaneous bandwidth requirements regularly, and at a sub-second frequency, to all other servers in the server pool. Once each server has sent its data to all the others, each one has global knowledge of the demands on the shared bandwidth. Therefore, each server is able to work out locally and optimally its entitlement to the available global bandwidth and sends only as much data as it is entitled to transmit under applicable policies. This methodology permits bandwidth priorities to be established for bandwidth which is shared across all servers.

The flow director 540 provides load balancing. The flow director decides whether a new flow should be accepted locally or directed to another host for processing. In the latter case, the flow director 540 converts the receive packets to transmit packets, and encodes them in a format to identify them to the remote host to which they will be forwarded. Symmetrically, the flow director 540 recognizes packets that have been forwarded from other hosts and converts them back to the format expected by higher layers of the Internet Protocol stack, just as though they had originally been accepted by the local host.

The Address Resolution Protocol (ARP) interceptor 560 receives ARP requests generated by the operating system to prevent network equipment, like switches and routers, becoming confused when the flow director configures an identical virtual Internet Protocol address on multiple servers.

User-Space Components

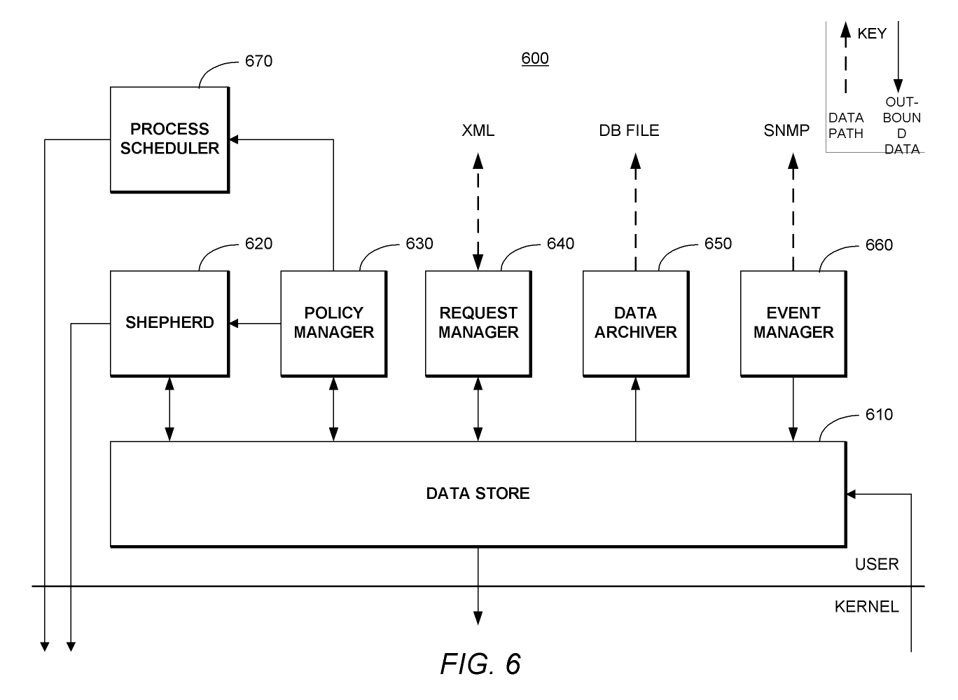

FIG. 6 is a block diagram 600 illustrating the user space modules or daemons of the system of the present invention. As shown, the user-space modules include a data store 610, a shepherd 620, a policy manager 630, a request manager 640, a data archiver 650, an event manager 660, and a process scheduler 670. Although these components or daemons are separated into logically distinct modules at FIG. 6, they typically comprise one physical daemon in practice. Several components of the daemon are fully distributed in that they communicate with their corresponding peers on each server in the pool; the distributed daemons communicate with their peers using the messaging protocol 510 illustrated at FIG. 5 and described above. The remaining components are oblivious of their peer instances and operate essentially on their own.

The system's data store 610 is fully distributed, persistent and low-latency. The data store 610 is used by the system's distributed daemons that need to share data between their peer instances. Each instance of the data store writes persistent data to the local disk of the host. In addition, a host's persistent data is redundantly replicated on the local disk of a configurable number of peer hosts; by doing so, the data held by any failed host is recoverable by the remaining hosts.

The shepherd daemon 620 is a distributed component which organizes and maintains the set of servers in the pool. The shepherd daemon 620 keeps the configuration of the servers in the kernel which can be made available to other components that need to discover the state of the servers in the pool. The shepherd daemon 620 is responsible for updating the pool configuration to reflect the servers that are alive.

The policy manager 630 is a distributed component and comprises the heart of the system's intelligence. The policy manager 630 manages the resources of the server pool by tracking the policies specified for programs (applications) and the available CPU and bandwidth resources in the pool. The policy manager 630 monitors the resource utilization of all applications, jobs, processes, and flows, from the events delivered to it by the flow classifier 530 (as shown at FIG. 5), and records this information in the data store. The policy manager 630 is also capable of making scheduling decisions for applications based on its knowledge of the available resources in the server pool. The policy manager 630 interfaces with the user via the request manager 640.

The request manager 640 receives connections from the user interface. The request manager 640 authenticates users and validates XML requests for data and policy adjustment from the user. The request manager 640 then passes valid requests to the appropriate server daemons, like the data store 610 or the policy manager 630, and translates their responses into XML before transmitting them back to the client.

The data archiver 650 moves non-essential records from the data store 610 to an archive file. The data archiver 650 also allows these archive files to be mounted for access by the data store 610 at a later date.

The event manager 660 reads “events” (i.e., asynchronous data elements) which are generated by the system's kernel modules to supply state information to the daemon components. The event manager 660 can be configured by the user to take action, like sending an email or running a script, whenever specific events occur. The event manager 660 also generates Simple Network Management Protocol (SNMP) traps to signal problems with application policies and server failures, which provides a way to interface with prevalent management tools, such as HP Openview and Tivoli, using standardized mechanisms.

The process scheduler 670 enforces the CPU component of a resource policy. The policy manager 630 communicates the CPU entitlement of each program (application) to the process scheduler 670, which then instructs the operating system on the priority of each one. Additionally, the process scheduler 670 monitors all processes running on the server and generates events to indicate to the policy manager 630 the CPU and memory utilization of each process.

On each individual server, the process scheduler 670 of the system controls the real-time dynamic allocation of CPU power to each application running on a particular server by translating the resource allocation provided by the resource policy into the relevant operating system priorities. The process scheduler 670 instructs the local operating system (e.g., Linux, Solaris, Windows, or the like) on the server to schedule the appropriate slices of the available CPU power to each of the applications based on the established priorities. For example, in a Unix or Linux environment standard “niceo” system calls can be used to schedule portions of the CPU resources available locally on a particular server in accordance with the resource policy. On some UNIX and Linux systems there are additional mechanisms that can also be used to allocate CPU resources. For example, on a Sun Solaris system, the Solaris Resource Manager mechanism can be used for allocating resources based on the resource policy. Similarly, on Windows servers, the Windows Resource Manager can be used to schedule portions of the CPU resources.

User Interface

The system can be configured and controlled using either a graphical user interface or the command line. The graphical user interface connects remotely to any of the servers in the pool and presents a unified view of the servers and applications in the server pool. As previously described, the user interface of the currently preferred embodiment allows resource policies to be created and edited, and guides the user with the syntax of the rules. The user interface also allows the user to select a number of application instances and collect them into an application. The user can also explicitly execute a number of stored application detection rules stored provided by the system.

Methods of Operation

The following discussion describes at a high level the operations that occur in the system of the currently preferred embodiment. These operations include activities that occur at scheduled intervals (e.g., triggered by high frequency and low frequency timers) as well as unscheduled actions that occur in response to events of interest (e.g., particular triggering conditions). The following pseudocode and description presents method steps that may be implemented using computer-executable instructions, for directing operation of a device under processor control. The computer-executable instructions may be stored on a computer-readable medium, such as CD, DVD, flash memory, or the like. The computer-executable instructions may also be stored as a set of downloadable computer-executable instructions, for example, for downloading and installation from an Internet location (e.g., Web server). The system of the present invention operates in a manner that is comparable to an operating system in that the system operates in an environment in which a number of different events occur from time to time. The system is event driven and responds to events and demands.

In the currently preferred embodiment components of the system reside on each of the servers in the server pool being managed and interoperate with each other to provide global awareness about the data center environment and enable local resource allocation decisions to be made on a particular server with knowledge of global concerns. On servers on which components of the system are in operation, such components run alongside the operating system and operate on three different levels as described in the following pseudocode:

Pseudocode illustrating system operations

-
-
-------------------------------------------------

| | |
|---|---|
| 1: | Configure the system; initialize high frequency timers |

, low
frequency timers, application policies and action triggers.
2:

| | | |
|---|---|---|
| 3: | WHILE (TRUE) | % i.e. repeat continuously |
| 4: | | |

| | |
|---|---|
| 5: | SLEEP until timer expires, trigger condition is met, o |

r user

| | |
|---|---|
| 6: | issues request |
| 7: | |
| 8: | IF high frequency timer expired THEN |
| 9: | |

| | |
|---|---|
| 10: | 1. Exchange status information among the server |

s in the

| | |
|---|---|
| 11: | server pool, to enable intelligent management o |

f shared

| | |
|---|---|
| 12: | global resources (e.g., server pool bandwidth) |
| 13: | |

| | |
|---|---|
| 14: | and/or |
| 15: | |
| 16: | 2. Allocate shared resources (e.g., bandwidth) to |

| | |
|---|---|
| 17: | applications based on their policies and instant |

aneous

| | |
|---|---|
| 18: | demand for these resources. |
| 19: | |

| | |
|---|---|
| 20: | ENDIF |
| 21: | |
| 22: | IF low frequency timer expired THEN |
| 23: | |

| | |
|---|---|
| 24: | 3. Identify new processes and processes that finis |

hed

| | |
|---|---|
| 25: | execution on the servers in the server pool, org |

anize new

| | |
|---|---|
| 26: | processes into applications and set their policie |

s.
27:

| | |
|---|---|
| 28: | and/or |
| 29: | |
| 30: | 4. Exchange server pool information among the |

| | |
|---|---|
| 31: | servers to maintain the server pool and enforce |

distributed application policies.
32:

| | |
|---|---|
| 33: | and/or |
| 34: | |
| 35: | 5. Sample resource utilization (e.g., CPU, memory, |

disk input/output,

| | |
|---|---|
| 36: | bandwidth) for all applications running, and (a) |

record

| | |
|---|---|
| 37: | relevant resource utilization (e.g., changes in th |

e
utilization rates), (b) adjust load balancing configuration.
38:

| | |
|---|---|
| 39: | and/or |
| 40: | |
| 41: | 6. Archive data recorded on the live server pool o |

n archive

| | |
|---|---|
| 42: | server. |
| 43: | |

| | |
|---|---|
| 44: | ENDIF |
| 45: | |
| 46: | IF trigger conditions are met OR user issued reques |

t THEN
47:

| | |
|---|---|
| 48: | 7. Organize network traffic into subsets whose re |

source

| | |
|---|---|
| 49: | utilization is monitored and managed atomicall |

y (e.g.,

| | |
|---|---|
| 50: | based on the protocol, sender and/or receiver I |

P

| | |
|---|---|
| 51: | address/port). Done as new network traffic hap |

pens.
52:

| | |
|---|---|
| 53: | and/or |
| 54: | |
| 55: | 8. Handle user requests (a) to modify grouping of |

processes

| | |
|---|---|
| 56: | and network traffic into applications; (b) to chan |

ge

| | |
|---|---|
| 57: | application policies; (c) set up load balancing fo |

r

| | |
|---|---|
| 58: | specific applications; (d) set up actions to be ta |

ken

| | |
|---|---|
| 59: | when special conditions are met (e.g., the policy |

cannot

| | |
|---|---|
| 60: | be realized for an application due to insufficient |
| 61: | resources); (e) to configure the system. |
| 62: | |

| | |
|---|---|
| 63: | and/or |
| 64: | |
| 65: | 9. Handle queries for information about server an |

d

| | |
|---|---|
| 66: | application resource utilization, state, policy, et |

c.
67:

| | |
|---|---|
| 68: | and/or |
| 69: | |
| 70: | 10. Back-up archived data on the archive server, |

and delete

| | |
|---|---|
| 71: | backed-up data from the live server pool. |
| 72: | |

| | |
|---|---|
| 73: | and/or |
| 74: | |
| 75: | 11. Take pre-set actions when special conditions |

are met

| | |
|---|---|
| 76: | (e.g., hardware failures, insufficient resources t |

o

| | |
|---|---|
| 77: | realize an application policy). |
| 78: | |

| | |
|---|---|
| 79: | and/or |
| 80: | |
| 81: | 12. Set-up automatic policy management |

| | |
|---|---|
| 82: | triggers that dictate how the policy of an |

application

| | |
|---|---|
| 83: | or its allocation to the application components |

change

| | |
|---|---|
| 84: | over time (e.g., when a high priority transaction |

is

| | |
|---|---|
| 85: | handled). Automatically adjust application poli |

cies

| | |
|---|---|
| 86: | as required when these triggers are met. |
| 87: | |

| | |
|---|---|
| 88: | ENDIF |
| 89: | |

| | |
|---|---|
| 90: | ENDWHILE |

As shown above, there are three levels or groups of activity that occur in the system of the currently preferred embodiment. The first two levels are high frequency and low frequency activities which occur at scheduled intervals. These actions are triggered by high frequency and low frequency timers, respectively. The third category of activities comprise unscheduled actions that occur in response to events of interest, such as user or administrator input or the occurrence of particular triggering conditions.

The specific time intervals that are used for the scheduled high frequency and low frequency activities may be configured by a user or administrator. For example, the same interval (e.g., a tenth of a second) may be used for all high frequency activities or a different interval may be used for different activities. In a typical environment, the high frequency timer(s) are set to a few milliseconds (e.g., every 10 milliseconds or 50 milliseconds), while the low-frequency timer(s) are usually sent to an interval of a few seconds (e.g., 2-5 seconds). A user or administrator may select an interval based upon the particular requirements of a given data center environment. For example, a longer time interval may be selected in an environment having a large number of servers (e.g., 200 servers or more) in order to reduce the impact on available network bandwidth.

The activities that occur at a high frequency (i.e., when a high frequency timer expires) are illustrated above at lines 8 through 20. As shown, these high frequency activities include: (1) exchanging status information among servers in the server pool; and (2) allocating shared resources to programs (e.g., application programs) based upon their policies and demand for resources. These actions are performed at a high frequency so that almost instantaneous responsiveness to rapidly changing circumstances is provided. This degree of responsiveness is required in order to avoid wasting resources (e.g., bandwidth) and to enable the system to promptly react to changing demands (e.g., spikes in demand for resources). Consider the example of a bandwidth intensive service with high priority and low priority users that are streaming video sharing the same bandwidth resources. If a high priority user pauses the video stream, additional bandwidth resources will instantaneously be available that can be allocated to other processes, including low priority users of the bandwidth intensive streaming service.

The servers managed by the system of the present invention exchange information in order to make each server globally aware of the demands on shared resources (e.g., bandwidth) and the operational status of the system. Based upon this information, each server can then allocate available local resources based upon established policies and priorities. Without this awareness about overall demands for data center resources a particular server may, for example, send packets via a network connection without any consideration of the impact this traffic may have on the overall environment. In the absence of global awareness, if a server has a communication that is valid, the server will generally send it. Without information about competing demands for bandwidth shared amongst a group of servers, the local server can only make decisions based on local priorities or rules and is unable to consider other more important, global (e.g., organization-wide) priorities. With global awareness, components of the system of the present invention operating on a given server may act locally while thinking globally. For instance, a local server may delay transmitting packets based upon information that an application with a higher priority operating on another server requires additional bandwidth.

In addition to the high frequency activities described above, there are other actions that are also taken regularly, but that do not need to be performed multiple times per second. As shown at lines 22 through 44 above, lower frequency activities which are typically performed every few seconds include the following: (3) identifying and organizing processes into applications and setting their resource policies; (4) exchanging server pool membership information; (5) sampling and recording resource utilization; and (6) archiving data to an archive server. Each of these lower frequency activities will now be described.

Identifying and organizing processes is a local activity that is performed on each server in the server pool. New processes that are just starting on a server are identified and tracked. Processes that cease executing on the server are also identified. New processes are organized into applications (i.e., identified and grouped) so that they may be made subject to a resource policy (sometimes referred to herein as a service level agreement or “SLA”) previously established for a given program or application. For example, a new process that appears is identified as being associated with a particular application. This enables resources (e.g., local CPU resources of a given server) to be allocated on the basis of an established resource policy applicable to the identified application.

Another low frequency activity is exchanging server pool information among servers to maintain the server pool and enforce distributed application policies. The high frequency exchange of status information described above may, for example, involve exchanging information 50 times a second among a total of 100 servers. Given the volume of information being exchanged, it is important to know that each of these servers remains available. In a typical data center environment in which the present invention is utilized, the servers are organized into clusters which exchange status information 10 times per second about the shared bandwidth. If one of these servers or server clusters fails or is otherwise unavailable, this lower frequency exchange of server pool membership information will detect the unavailability of the server or cluster within a few seconds. In the presently preferred embodiment, detecting server availability is performed as a lower frequency activity because making this check every few milliseconds is likely to be less accurate (e.g., result from a brief delay or a number of reasons other than failure or unavailability of a server) and may also consume bandwidth resources unnecessarily. The exchange of membership information makes the system more resilient to fault as the failure or unavailability of a server can be determined in a short period of time (e.g., a few seconds). This enables resource allocations to be adjusted on the remaining servers in accordance with an established policy. If desired, a user may also be notified of the event as an alternative to (or in addition to) the automatic adjustment of resource allocations.

Another lower frequency activity that is described at lines 35 to 37 above is sampling and recording utilization of resources (e.g., utilization of CPU, memory, and band-width by applications running in the data center). As previously described the utilization of resources is monitored by the system. For example, every few seconds the resources used by each application on a particular server is recorded to enable a user or administrator to determine how resources are being used and the effectiveness of any SLA (resource policy) that is in effect. This sampling also enables the system to adjust the load balancing configuration.

The data that is recorded and other data generated by the system is also periodically archived as indicated at lines 41-42. A considerable quantity of information is generated as the system of the present invention is operating. This information is archived to avoid burdening the server pool with monitoring information. Historical monitoring information is useful for reporting and analysis of resource utilization and other such purposes, but is not required for ongoing performance of monitoring or enforcement operations of the system.

The third category of activities are actions taken in response to events (e.g., occurrence of trigger conditions) or demands (e.g., user requests) which do not occur at regular intervals. One of these events is the opening of a new network connection. When a new connection is made, the system identifies what the connection relates to (e.g., which application it relates to) so that the appropriate resource policy may be applied. As network traffic is received, it is identified based upon the protocol, sender, and/or receiver IP address and port as shown at lines 48-51. Based on this identification, the traffic can be monitored and managed by the system. For example, traffic associated with a particular application having a low priority may be delayed to make bandwidth available for other higher priority traffic.

Another group of events that are handled by the system of the present invention are user requests or commands. This includes responding to user requests to modify grouping of processes and network traffic into applications, to change application (i.e., resource) policies, and various other requests received either via command line or graphical user interface. A user or administrator of the system (e.g., a data center manager) may establish a number of different policies or conditions indicating when particular actions should be taken (e.g., indicating to the system what should happen in the event there are not sufficient resources available to satisfy the requirements of all SLAs). These requests may also come from a script running in the background, for example as a “cron” daemon in a Unix or Linux environment. A “cron” daemon in Unix or Linux is a program that enables tasks to be carried out at specified times and dates. For instance, a resource policy (SLA) may provide that a particular application is to have a minimum of 40% of the CPU resources on nodes (servers) 20 through 60 of a pool of 100 servers during a specified period of time (e.g., Monday to Friday) and 20% of the same resources at other times (e.g., on Saturday and Sunday). The policy may also provide that in the event of failure of one or more of the nodes supporting this application that these percentages should be increased (e.g., to 50%) on the remaining available servers. Other actions may also be taken in response to the failure, as desired. The system provides users with a number of different options for configuring the system and the policies (or SLAs) that it is monitoring and enforcing.

The system also responds to user requests for information. These requests may include requests for information about server and application resource utilization, inquiries regarding the status of the system, and so forth. A user or administrator may, for instance, want to know the current status of the system before making adjustments to a resource policy. Users also typically require information in order to prepare reports or analyze system performance (e.g., generate histograms based on historical resource utilization information).

Other actions may also be taken as events occur. For example, a back-up of data from the live system to an archive may be initiated by a trigger condition or based on a user request as illustrated at lines 70-71. Although data is usually backed up regularly as described above, certain events may occur which may require data to be moved to an archive at other times or in a different manner. The system is also configurable to provide for other actions to be taken in response to particular events. For example, the system may automatically take particular actions in response to hardware failures, insufficient resources, or other trigger events. As shown at lines 81-84, an automatic SLA management trigger may be established to dictate how a resource policy may be changed over time or based on certain events. For instance, additional CPU and/or bandwidth resources may be made available to a particular application for handling a high priority transaction. As another example, application triggers may be set to provide for one or more resources policies to be automatically adjusted in response to particular events.

The system of the present invention enables resource usage to be monitored and controlled in an intelligent, systematic fashion. The exchange of information provides each server in a server pool with awareness of the overall status of the data center environment and enables a resource policy to be applied locally on each server based upon knowledge of the overall environment and the demands being placed on it. For example, a data center including 100 servers may be supporting several Internet commerce applications. Access to the shared bandwidth within the server pool and out from the server pool to the Internet is managed intelligently based upon information about the overall status of the data center rather than by each server locally based solely on local priorities (or manually by a data center manager). The system facilitates a flexible response to various events that can and do occur from time to time, such as hardware failure, fluctuating demands for resources, changing priorities, new applications, and various other conditions. The internal operations of the system of the present invention will now be described in greater detail.

Detailed Internal Operation

Exchange of Information Between Servers in Server Pool

Information is exchanged by distributed components of the present invention operating on different servers in a server pool. The following code segments illustrate the process for exchange of information between servers in the server pool. The process for exchange of information generally is triggered by an alarm (i.e., expiration of a high frequency timer). The alarm is triggered at regular intervals (e.g., the minimum interval of registered modules involved in the information exchange) and causes all registration entries to be updated. The updated information is then disseminated to the other nodes (i.e., other servers in the server pool) so that they can receive a single callback during their information exchange period. The “sychron_info_exch_alarm” function that triggers update of registration entries is as follows:

| | |
|---|---|
| 1: | void sychron_info_exch_alarm(void *alarm_data) { |

| 2: | sos_clock_t time_now; | |
|---|---|---|
| 3: | int | i, j, rc; |

| | |
|---|---|
| 4: | syc_uint32_t backoff_rand; |
| 5: | |
| 6: | if (!syc_info_exch) |

| | |
|---|---|
| 7: | return; |
| 8: | |
| 9: | |
| 10: | if (syc_info_exch−>this_nodeid = = SYCHRON_MAX_C |

LUSTER_NODES) {

| | |
|---|---|
| 11: | syc_info_exch−>this_nodeid = sychron_server_mys |

elf( );

| | |
|---|---|
| 12: | if (syc_info_exch−>this_nodeid = = SYCHRON_MAX_{—} |

CLUSTER_NODES) {

| | |
|---|---|
| 13: | return; |

| | |
|---|---|
| 14: | } |
| 15: | slog_msg(SLOG_INFO,“sychron_info_exch(node %d |

initialising random seed)”,

| | |
|---|---|
| 16: | syc_info_exch−>this_nodeid); |

| | |
|---|---|
| 17: | syc_irand_seed(2*syc_info_exch−>this_nodeid + 1, |

| | |
|---|---|
| 18: | &syc_info_exch−>random_state); |

| | |
|---|---|
| 19: | } |
| 20: | sychron_server_active(syc_info_exch−>active_nodes); |
| 21: | syc_info_exch−>master_nodeid = |

syc_nodeset_first(syc_info_exch−>active_nodes);

| | |
|---|---|
| 22: | sychron_info_exch_parameters( ); |
| 23: | |
| 24: | backoff_rand = syc_irand(&syc_info_exch−>random_{—} |

state);

| | |
|---|---|
| 25: | time_now = sos_clocknow( ); |
| 26: | for(i=0;i<=SYCHRON_INFO_EXCH_CODE_MAX; i++) { |

| | |
|---|---|
| 27: | syc_info_exch_reg_t *reg = syc_info_exch−>registra |

tions[i];

| | |
|---|---|
| 28: | if (reg) { |

| | |
|---|---|
| 29: | if (reg−>next_trigger <= time_now) { |

| | |
|---|---|
| 30: | syc_info_exch_reg_data_t *info; |
| 31: | |
| 32: | info = &reg−>most_recent[syc_info_exch−>this_nod |

eid];

| | |
|---|---|
| 33: | reg−>next_trigger += reg−>gap; |
| 34: | |

| | |
|---|---|
| 35: | sychron_info_exch_reg_attempt_critical_section(r |

eg,{

| | |
|---|---|
| 36: | rc = reg−>send(i,info−>data,&info−>nbytes); |
| 37: | if (rc) |

| | |
|---|---|
| 38: | reg−>stats.send_callback_nochange++; |

| | |
|---|---|
| 39: | else { |

| | |
|---|---|
| 40: | reg−>retransmit_range = 1; |
| 41: | reg−>retransmit_count = 0; |
| 42: | reg−>stats.send_callback_change++; |
| 43: | syc_nodeset_set(reg−>most_recent_recvd, |

syc_info_exch−>this_nodeid);

| | | |
|---|---|---|
| 44: | info−>timestamp | = time_now; |

| | | |
|---|---|---|
| 45: | info−>ttl | = syc_info_exch−>max_ttl; |

| | |
|---|---|
| 46: | SYC_ASSERT(info−>nbytes <= reg−>max_nbytes); |

| | |
|---|---|
| 47: | } |
| 48: | |

| | |
|---|---|
| 49: | if ((reg−>flags & |

SYCHRON_INFO_EXCH_FLAGS_CHECKPOINT_DATA) &&

| | |
|---|---|
| 50: | (syc_info_exch−>master_nodeid = = |

syc_info_exch−>this_nodeid)) {

| | |
|---|---|
| 51: | syc_nodeset_iterate(syc_info_exch−>active_nodes, |

j,{

| | |
|---|---|
| 52: | syc_info_exch_reg_data_t *info_j = &reg−>most |

_recent[j];

| | |
|---|---|
| 53: | syc_info_exch_reg_data_t *frozen_j = &reg−>froz |

en[j];
54:

| | |
|---|---|
| 55: | if (info_j−>timestamp > frozen_j−>timestamp) { |

| 56: | /* make sure this node sees the frozen entries */ | |
|---|---|---|
| 57: | syc_nodeset_set(reg−>frozen_recvd,j); | |
| 58: | frozen_j−>timestamp = info_j−>timestamp; | |
| 59: | frozen_j−>ttl | = info_j−>ttl; |

| | |
|---|---|
| 60: | frozen_j−>nbytes = info_j−>nbytes; |
| 61: | if (info_j−>nbytes) |

| | |
|---|---|
| 62: | syc_memcpy(frozen_j−>data,info_j−>data,info_j− |

>nbytes);

| | |
|---|---|
| 63: | } |
| 64: | }); |

| | |
|---|---|
| 65: | } |

| | |
|---|---|
| 66: | }); |
| 67: | |

| | |
|---|---|
| 68: | if (!reg−>uploaded) |

| | |
|---|---|
| 69: | sos_task_schedule_asap(&reg−>recv_all_task_reset_{—} |

recv);

| | |
|---|---|
| 70: | else |

| | |
|---|---|
| 71: | sychron_info_exch_recv_all_task_reset_recv(reg); |
| 72: | |

| | |
|---|---|
| 73: | if (!info−>ttl) { |

| | |
|---|---|
| 74: | if (reg−>retransmit_count) |

| | |
|---|---|
| 75: | reg−>retransmit_count−−; |

| | |
|---|---|
| 76: | else { |

| | |
|---|---|
| 77: | /* Updating ttl forces retransmit */ |
| 78: | info−>ttl = syc_info_exch−>max_ttl; |
| 79: | if (reg−>retransmit_range < SYC_INFO_EXCH_MAX |

_RETRANSMIT_PERIOD)

| | |
|---|---|
| 80: | reg−>retransmit_range |

| | |
|---|---|
| 81: | = syc_min(2*reg−>retransmit_range, |

| | |
|---|---|
| 82: | SYC_INFO_EXCH_MAX_RETRANSMIT_PERIOD); |

| | |
|---|---|
| 83: | if (!reg−>retransmit_range) |

| | |
|---|---|
| 84: | reg−>retransmit_range = SYC_INFO_EXCH_MAX_{—} |

RETRANSMIT_PERIOD;

| | |
|---|---|
| 85: | reg−>retransmit_count = backoff_rand % |

| | |
|---|---|
| 86: | ((syc_uint32_t)reg−>retransmit_range); |

| | |
|---|---|
| 87: | } |

| | |
|---|---|
| 88: | } /* zero ttl */ |

| | |
|---|---|
| 89: | } /* registration update period */ |

| | |
|---|---|
| 90: | } /* active registration */ |

| | |
|---|---|
| 91: | } /* forall registrations */ |
| 92: | |
| 93: | sos_task_schedule_asap(&syc_info_exch−>send_task) |

;

| | |
|---|---|
| 94: | } |

At lines 10-22 the node-id is set and a random number generator is then initialized. Next, at lines 24-33 the registrations are passed through to activate the send callback methods. A single random value is used for the back-off algorithm of all registrations, although the range is different for each registration, so retransmissions will occur out of phase, during different update periods. At lines 35-47 a lock is held over the send and receive-all callbacks so that they do not have to be re-entrant. The lock contention is low due to periodicity of the information exchange, so it is unlikely that the callbacks will overlap. A check is made as shown at lines 49-50 to determine if this node is the master. If this node is the master, then any registrations that require atomic data are copied to a “frozen” entry.

At lines 68-72, a check is made to make sure that data is not loaded multiple times. If an upload has not already occurred, an asynchronous thread is spawned to do the upload. If an upload has already happened, then the upload will probably not occur (this cannot be guaranteed as locks have not been set). The calls in either branch of the “if/else” statements at lines 68-72 are semantically equivalent: one branch performs the operation in-situ, and the other in a separate thread. As the protocol is lossy, the data registration entries are continually re-transmitted using a random exponential backoff as shown above commencing at lines 73.

The following “sychron_info_exch_prepare_send” function prepares a packet for data transmission. The creation of the packet is not protected by a lock as a freshly qcell-allocated packet is used for the payload. However when accessing the registration data, the registration critical section is used.

| | |
|---|---|
| 1: | STATIC int synchron_info_exch_prepare_send(syc_uint16 |

_t master_ttl,

| | |
|---|---|
| 2: | syc_nodeid_t ignore_node) { |

| 3: | syc_info_exch_pkt_reg_header_t *data_header; | |
|---|---|---|
| 4: | syc_info_exch_reg_t | *reg; |
| 5: | syc_info_exch_reg_data_t | *info; |

| | | |
|---|---|---|
| 6: | int | rc, i, j, elems_tot, nbytes, |

misaligned,

| | |
|---|---|
| 7: | reg_code, freeze, no_frozen; |

| | | |
|---|---|---|
| 8: | char | *payload; |

| | | |
|---|---|---|
| 9: | syc_nodeset_t | send_set; |
| 10: | syc_nodeset_t | transfer_set; |

| | | |
|---|---|---|
| 11: | syc_info_exch_pkt_header_t | *packet; |

| | | |
|---|---|---|
| 12: | static syc_uint32_t | reg_fairness = 0; |
| 13: | | |

| | |
|---|---|
| 14: | packet = sqi_qcell_alloc(&syc_info_exch−>packet_all |

ocator);

| | |
|---|---|
| 15: | if (!packet) |

| | |
|---|---|
| 16: | return −ENOMEM; |

| | |
|---|---|
| 17: | no_frozen = 0; |
| 18: | elems_tot = 0; |
| 19: | nbytes = sizeof(syc_info_exch_pkt_header_t); |
| 20: | data_header |

| | |
|---|---|
| 21: | = (syc_info_exch_pkt_reg_header_t*) (packet+1); |

| | |
|---|---|
| 22: | SYC_ASSERT(!(((syc_uintptr_t) data_header) % |

SYC_BASIC_TYPE_ALIGNMENT));
23:

| | |
|---|---|
| 24: | reg_fairness = (reg_fairness + 1) % |

(SYCHRON_INFO_EXCH_CODE_MAX+1);

| | |
|---|---|
| 25: | for(i=0;i<=SYCHRON_INFO_EXCH_CODE_MAX; i++) { |

| | |
|---|---|
| 26: | reg_code = (reg_fairness + i) % |

(SYCHRON_INFO_EXCH_CODE_MAX+1);

| | |
|---|---|
| 27: | reg = syc_info_exch−>registrations[reg_code]; |
| 28: | if (reg) { |
| 29: | |

| | |
|---|---|
| 30: | syc_nodeset_zeros(send_set); |
| 31: | syc_nodeset_iterate(syc_info_exch−>active_nodes, |

j,{

| | |
|---|---|
| 32: | freeze = master_ttl && (reg−>flags & |

| | |
|---|---|
| 33: | SYCHRON_INFO_EXCH_FLAGS_CHECKPOINT_{—} |

DATA);

| | |
|---|---|
| 34: | info = (freeze)?&reg−>frozen[j]:&reg−>most_recent |

[j];

| | |
|---|---|
| 35: | if (info−>timestamp && info−>ttl) { |

| | |
|---|---|
| 36: | no_frozen += freeze; |
| 37: | syc_nodeset_set(send_set,j); |

| | |
|---|---|
| 38: | } |

| | |
|---|---|
| 39: | }); |
| 40: | |
| 41: | /* no updates... onto the next registration */ |
| 42: | if (syc_nodeset_isempty(send_set)) |

| | |
|---|---|
| 43: | continue; |
| 44: | |

| | |
|---|---|
| 45: | { |

| | |
|---|---|
| 46: | int thisnode_set, max_elems; |
| 47: | |
| 48: | thisnode_set = |

syc_nodeset_isset(send_set,syc_info_exch−>this_nodeid);
49:

| | |
|---|---|
| 50: | if (thisnode_set) |

| | |
|---|---|
| 51: | syc_nodeset_clr(send_set,syc_info_exch−>this_node |

id);
52:

| | |
|---|---|
| 53: | if (master_ttl && |

| | |
|---|---|
| 54: | (reg−>flags & SYCHRON_INFO_EXCH_FLAGS_CHECK |

POINT_DATA))

| | |
|---|---|
| 55: | max_elems = (SYC_INFO_EXCH_MAX_MTU − nbytes) |

/

| | |
|---|---|
| 56: | (reg−>max_nbytes + |

| | |
|---|---|
| 57: | sizeof(syc_info_exch_pkt_reg_header_t) + |

| | |
|---|---|
| 58: | SYC_BASIC_TYPE_ALIGNMENT); |

| | |
|---|---|
| 59: | else |

| | |
|---|---|
| 60: | max_elems = syc_info_exch−>max_elems_send; |

| | |
|---|---|
| 61: | syc_nodeset_random_subset(&syc_info_exch−>rando |

m_state,

| | |
|---|---|
| 62: | send_set, |
| 63: | transfer_set, |
| 64: | (max_elems > 1)?max_elems-1:1); |

| | |
|---|---|
| 65: | if (thisnode_set) |

| | |
|---|---|
| 66: | syc_nodeset_set(transfer_set,syc_info_exch−> this_n |

odeid);

| | |
|---|---|
| 67: | } |
| 68: | |
| 69: | /* Make sure data does not change under our feet |

*/

| | |
|---|---|
| 70: | sychron_info_exch_reg_attempt_critical_section (re |

g,{

| | |
|---|---|
| 71: | syc_nodeset_iterate(transfer_set,j,{ |

| | |
|---|---|
| 72: | info = (master_ttl && (reg−>flags & |

| | |
|---|---|
| 73: | SYCHRON_INFO_EXCH_FLAGS_CHECKPOINT_DAT |

A))?

| | |
|---|---|
| 74: | &reg−>frozen[j]:&reg−>most_recent[j]; |

| | | |
|---|---|---|
| 75: | if ((elems_tot >= 255) | \|\| |

/* syc_uint8_t in payload*/

| | |
|---|---|
| 76: | (nbytes + |
| 77: | sizeof(syc_info_exch_pkt_reg_header_t) + |
| 78: | info−>nbytes + |
| 79: | SYC_BASIC_TYPE_ALIGNMENT) > SYC_INFO_EXCH |

_MAX_MTU)

| | |
|---|---|
| 80: | syc_info_exch−>stats.send_truncated++; |
| 81: | |

| | |
|---|---|
| 82: | else if (info−>timestamp && info−>ttl) { |

| | | |
|---|---|---|
| 83: | data_header−>ttl | = info−>ttl−−; |

| | |
|---|---|
| 84: | data_header−>timestamp = info−>timestamp; |
| 85: | data_header−>nodeid = j; |
| 86: | data_header−>reg_code = reg_code; |
| 87: | data_header−>nbytes = info−>nbytes; |
| 88: | payload = (char*) (data_header+1); |
| 89: | if (info−>nbytes) |

| | |
|---|---|
| 90: | syc_memcpy(payload,info−>data,info−>nbytes); |

| | |
|---|---|
| 91: | misaligned = |

(info−>nbytes+sizeof(syc_info_exch_pkt_reg_header_t))%

| | |
|---|---|
| 92: | SYC_BASIC_TYPE_ALIGNMENT; |

| | |
|---|---|
| 93: | data_header−>padding = |

| | |
|---|---|
| 94: | !misaligned?0:SYC_BASIC_TYPE_ALIGNMENT-misa |

ligned;

| | |
|---|---|
| 95: | nbytes += sizeof(syc_info_exch_pkt_reg_header_t) |

+

| | |
|---|---|
| 96: | data_header−>nbytes + data_header−>pad |

ding;

| | |
|---|---|
| 97: | data_header |

| | |
|---|---|
| 98: | = (syc_info_exch_pkt_reg_header_t*)(payload + |

| | |
|---|---|
| 99: | data_header−>nbytes + |
| 100: | data_header−>padding); |

| | |
|---|---|
| 101: | elems_tot++; |
| 102: | reg−>stats.send_updates[j]++; |

| | |
|---|---|
| 103: | } |

| | |
|---|---|
| 104: | }); |

| | |
|---|---|
| 105: | }); |

| | |
|---|---|
| 106: | } /* active registration */ |

| 107: | } /* for each registration */ | |
|---|---|---|
| 108: | | |
| 109: | packet−>elems | = elems_tot; |
| 110: | packet−>nbytes | = nbytes; |

| 111: | packet−>master_ttl = no_frozen?master_ttl:0; | |
|---|---|---|
| 112: | packet−>via | = syc_info_exch−>this_nodeid; |
| 113: | | |
| 114: | if (!elems_tot) | |

| | |
|---|---|
| 115: | rc = −ENODATA; |
| 116: | |

| | |
|---|---|
| 117: | else { |

| | |
|---|---|
| 118: | yc_nodeset_copy(send_set,syc_info_exch−>active |

_nodes);

| | |
|---|---|
| 119: | syc_nodeset_clr(send_set,syc_info_exch−>this_no |

deid);

| | |
|---|---|
| 120: | syc_nodeset_clr(send_set,ignore_node); |
| 121: | if (master_ttl) |

| | |
|---|---|
| 122: | syc_nodeset_clr(send_set,syc_info_exch−>master |

_nodeid);

| | |
|---|---|
| 123: | rc = sychron_info_exch_send(packet, |

| | |
|---|---|
| 124: | send_set, |
| 125: | (master_ttl && |
| 126: | (master_ttl < syc_info_exch−>max_ttl))? |
| 127: | syc_info_exch−>rest_mates: |
| 128: | syc_info_exch−>first_mates); |

| | |
|---|---|
| 129: | } |
| 130: | sqi_qcell_free(&syc_info_exch−>packet_allocator,pa |

cket);

| | |
|---|---|
| 131: | return rc; |

| | |
|---|---|
| 132: | } |

At lines 15-22 the packet to be transmitted is built up. The packet is local to this thread/routine, so the concurrency is fine if send is called by multiple threads (i.e., timer versus master incoming). Registration fairness of every call is updated in a round-robin fashion as provided at lines 24-27. This is done to ensure that large early registrations do not starve later ones. If a packet is truncated, then during the next iteration, a different ordering of data is used. In other words, a combination of the round-robin approach and the randomization of which data items are sent ensures that available space is allocated appropriately.

At lines 30-43 a map of the nodes that have relevant data to send is built. Generally, only the data that has changed during the last few alarm periods is sent and a subset of the data is selected to send later. The “ttl” field (e.g., at line 35) is the lifetime (or “time to life”) of the packet, as the data is sent multiple times because of the lossy nature of the transmission protocol. Next commencing at line 45, a random subset of the entries to be transferred is selected. If the master node is doing a frozen send, then the limit is the number of entries that will fit into the packet. Otherwise only up to “SYC\_INFO\_EXCH\_SIZE” entries are exchanged, but always including this node's entry if there is a change.

At lines 70-80, the payload to be sent is built up. The accumulation of the sent packet is stopped if either of the following hard maxima are reached: the number of elements in a packet becomes larger than 255 due to the 8-bit field in the payload as shown at line 75; or the size of the packet is greater than the MTU size of the network as shown at line lines 76-79. If a premature stop does occur, then the protocol is safe and fair, as the next send will use a random subset of the data. At line 82 the test for non-zero “ttl” is checked again, as when it was checked previously for the send, the locks were not set, and it could have been concurrently altered by another thread sending a payload out (i.e., a master transfer). If there is a packet for transmission then the below “sychron_info_exch_send” function is called to send the packet as shown at lines 114-132. However, the packet is not sent back to the current node or to the master node-id if the message has just come from that node.

The following “sychron_info_exch_send” function illustrates the methodology for sending the packet to a random subset of the available nodes.

| | |
|---|---|
| 1: | STATIC int sychron_info_exch_send(syc_info_exch_pkt_{—} |

header_t *pkt,

| | | |
|---|---|---|
| 2: | syc_nodeset_t | send_set, |

| | | |
|---|---|---|
| 3: | int | no_mates) { |

| 4: | syc_nodeset_t mates; | |
|---|---|---|
| 5: | int | i, j, rc, nbytes; |

| | |
|---|---|
| 6: | sos_netif_pkt_t raw_pkt; |
| 7: | |
| 8: | syc_nodeset_random_subset(&syc_info_exch−>rando |

m_state,

| | |
|---|---|
| 9: | send_set, |

| | |
|---|---|
| 10: | mates, |
| 11: | no_mates); |

| | |
|---|---|
| 12: | nbytes = pkt−>nbytes; |
| 13: | j = 0; |
| 14: | syc_nodeset_iterate(mates,i,{ |

| 15: | raw_pkt.syc_proto = SOS_NETIF_INFOX; | |
|---|---|---|
| 16: | raw_pkt.proto.sychron.nodeid = i; | |
| 17: | raw_pkt.total_len = nbytes; | |
| 18: | raw_pkt.num_vec = 1; | |
| 19: | raw_pkt.vec_in_place.iov_base = (void*)pkt; | |
| 20: | raw_pkt.vec_in_place.iov_len = nbytes; | |
| 21: | raw_pkt.vec | = &raw_pkt.vec_in_place; |

| | |
|---|---|
| 22: | rc = sos_netif_bottom_tx(&raw_pkt); |
| 23: | if (rc) |

| | |
|---|---|
| 24: | syc_info_exch−>stats.send_pkts_fail[i]++; |
| 25: | |

| | |
|---|---|
| 26: | else { |

| | |
|---|---|
| 27: | j++; |
| 28: | syc_info_exch−>stats.send_pkts[i]++; |
| 29: | syc_info_exch−>stats.send_bytes[i] += nbytes; |
| 30: | if (pkt−>master_ttl) { |

| | |
|---|---|
| 31: | syc_info_exch−>stats.send_master_pkts[i]++; |
| 32: | syc_info_exch−>stats.send_master_bytes[i] += nbyte |

s;

| | |
|---|---|
| 33: | } |

| | |
|---|---|
| 34: | } |

| | |
|---|---|
| 35: | ); |
| 36: | return (j?0:−ENODATA); |

| | |
|---|---|
| 37: | } |

As shown above at line 8, a “syc_nodeset_random_subset” method is called for sending the packet to a random subset of the available nodes. The above routine then iterates through this subset of nodes and sends packets to nodes that are available to receive the packet.

Bandwidth Management

The following code segments illustrate the methodology of the present invention for bandwidth management. In general, the amount of bytes which are queued and those being sent under a resource policy (or SLA) are calculated. The calculated amounts are fed into the per-pipe information exchange. The following “syc_bwman_shared_pipe_tx_info_exch_send” function prepares for a shared pipe information exchange:

1: int syc_bwman_shared_pipe_tx_info_exch_send(syc_uin

| | |
|---|---|
| 1: | int syc_bwman_shared_pipe_tx_info_exch_send(syc_uin |

t8_t reg_code,

| | | |
|---|---|---|
| 2: | void | *send_buffer, |

| | |
|---|---|
| 3: | syc_uint16_t *send_nbytes) { |

| | |
|---|---|
| 4: | syc_bwman_pipe_id_t pipe_id; |
| 5: | syc_bwman_shared_pipe_t *pipe; |
| 6: | syc_bwman_shared_pipe_config_t *pipe_config ; |
| 7: | |
| 8: | pipe_id = reg_code − SYCHRON_INFO_EXCH_CODE_ST |

ROBE_PIPE_MIN;

| | |
|---|---|
| 9: | if (pipe_id < 0 \|\| |

| | |
|---|---|
| 10: | reg_code > SYCHRON_INFO_EXCH_CODE_STROBE_{—} |

PIPE_MAX ||

| | |
|---|---|
| 11: | pipe_id >= SYC_BWMAN_MAX_PIPES) { |

| | |
|---|---|
| 12: | static sos_clock_t time_next_error = 0; |
| 13: | static syc_uint32_t error_count = 0; |
| 14: | |
| 15: | error_count++; |
| 16: | if (sos_clocknow( ) > time_next_error) { |

| | |
|---|---|
| 17: | slog_msg(SLOG_CRIT, |

| | |
|---|---|
| 18: | “syc_bwman_shared_pipe_tx_info_exch_send(un |

known pipe reg
%d) errors=%d”,

| | |
|---|---|
| 19: | reg_code, error_count); |

| | |
|---|---|
| 20: | time_next_error = sos_clocknow( ) + sos_clock_fro |

m_secs(5);

| | |
|---|---|
| 21: | } |
| 22: | return −EINVAL; |

| | |
|---|---|
| 23: | } |
| 24: | pipe_config = &pipe_config_table[pipe_id]; |
| 25: | sychron_server_active(active_nodes); |
| 26: | |
| 27: | syc_bwman_desc_booking_summary(pipe_config); |
| 28: | |

| | |
|---|---|
| 29: | \* |
| 30: | Update the information which will be shared with the |

other nodes.

| | |
|---|---|
| 31: | *\ |

| | |
|---|---|
| 32: | pipe = &pipe_table[pipe_id]; |
| 33: | pipe−>my_send_state.bytes_unbooked = pipe_config |

−>total_unbooked;

| | |
|---|---|
| 34: | vpipe−>my_send_state.bytes_booked = pipe_config− |

>total_booked;

| | |
|---|---|
| 35: | if (pipe_config−>total_booked > pipe_config−>total_{—} |

bytes) {

| | |
|---|---|
| 36: | static sos_clock_t time_next_error = 0; |
| 37: | static syc_uint32_t error_count = 0; |
| 38: | |
| 39: | error_count++; |
| 40: | if (sos_clocknow( ) > time_next_error) { |

| | |
|---|---|
| 41: | slog_msg(SLOG_WARNING, |

“syc_bwman_shared_pipe_tx_info_exch_send(INVARIANT: ”

| | |
|---|---|
| 42: | “booked=%d > total_bytes=%d errors=%d)”, |
| 43: | pipe_config−>total_booked, |
| 44: | pipe_config−>total_bytes, |
| 45: | error_count); |

| | |
|---|---|
| 46: | time_next_error = sos_clocknow( ) + sos_clock_fro |

m_secs(5);

| | |
|---|---|
| 47: | } |

| | |
|---|---|
| 48: | } |
| 49: | if (!syc_bwman_shared_pipe_delta(&pipe−>my_send_{—} |

state,

| | |
|---|---|
| 50: | &pipe−>recv_state[pipe_nodeid])) { |

| | |
|---|---|
| 51: | pipe−>stats.tx_schedules_send_nochange++; |
| 52: | return 1; |

| | |
|---|---|
| 53: | } else { |

| | |
|---|---|
| 54: | pipe−>stats.tx_schedules_send_change++; |
| 55: | syc_memcpy(send_buffer, |

| | |
|---|---|
| 56: | &pipe−>my_send_state, |
| 57: | sizeof(syc_bwman_shared_pipe_info_exch_t)); |

| | |
|---|---|
| 58: | *send_nbytes = sizeof(syc_bwman_shared_pipe_inf |

o_exch_t);

| | |
|---|---|
| 59: | return 0; |

| | |
|---|---|
| 60: | } |

| | |
|---|---|
| 61: | } |

The information which will be shared with the other nodes is updated as shown above at lines 32-24. The updated status information about the pipe is then sent to the other nodes. In general, the amount of bytes which are queued and those being sent under SLA (a resource policy or job policy) are calculated and fed into the per-pipe information exchange.

If more bytes were sent in the last interval than were allocated, these bytes are added to the queued bytes. This can occur because one can only send whole packets, so if there is 1 byte of “credit” and the next packet is of MTU size, then queue goes into debt by an amount equal to MTU—1. These bytes will effectively be sent on the next iteration. Transmission means the packet is handed on to the next layer. As the present approach involves modeling a limited bandwidth, it is likely that packets may actually not be transmitted on a WAN (wide area network) pipe until the next schedule, so the first bytes of “credit” awarded on the next interval will go into paying off this debt. Currently, a minimum booking request is always made, so the total duration (measured in bytes) of the interval can be determined to calculate this minimum booking as well as the fraction of the total which can be immediate. The intention of both is to prevent starvation of the IP traffic.

The information sent by each of the peer nodes is used by each node to determine how many bytes it can send as described in the following code segment:

| | |
|---|---|
| 1: | void syc_bwman_shared_pipe_tx_info_exch_recv_all |

(syc_uint8_t reg_code,

| | | |
|---|---|---|
| 2: | void | **buffer_arr, |

| | |
|---|---|
| 3: | syc_uint16_t *nbytes_arr, |

| | |
|---|---|
| 4: | syc_nodeset_t active) { |

| | |
|---|---|
| 5: | syc_int32_t total_bytes_booked; |
| 6: | syc_int32_t total_bytes_unbooked; |
| 7: | syc_int32_t total_bytes_queued; |
| 8: | syc_bwman_pipe_id_t pipe_id; |
| 9: | syc_bwman_shared_pipe_t *pipe; |
| 10: | syc_nodeid_t nodeid; |
| 11: | syc_bwman_shared_pipe_config_t *pipe_config ; |
| 12: | syc_bwman_shared_pipe_info_exch_t *my_recv_state; |
| 13: | syc_uint32_t num_active_nodes ; |
| 14: | |
| 15: | pipe_id = reg_code − SYCHRON_INFO_EXCH_CODE_S |

TROBE_PIPE_MIN;

| | |
|---|---|
| 16: | if (pipe_id < 0 \|\| |

| | |
|---|---|
| 17: | reg_code > SYCHRON_INFO_EXCH_CODE_STROBE_{—} |

PIPE_MAX ||

| | |
|---|---|
| 18: | pipe_id >= SYC_BWMAN_MAX_PIPES) { |
| 19: | |

| | |
|---|---|
| 20: | static sos_clock_t time_next_error = 0; |
| 21: | static syc_uint32_t error_count = 0; |
| 22: | |
| 23: | error_count++; |
| 24: | if (sos_clocknow( ) > time_next_error) { |

| | |
|---|---|
| 25: | slog_msg(SLOG_CRIT, |

| | |
|---|---|
| 26: | “syc_bwman_shared_pipe_recv_all(unknown pipe |

reg %d)
errors=%d”,

| | |
|---|---|
| 27: | reg_code,error_count); |

| | |
|---|---|
| 28: | } |
| 29: | return; |

| | |
|---|---|
| 30: | } |
| 31: | pipe = &pipe_table[pipe_id]; |
| 32: | my_recv_state = &pipe−>recv_state[pipe_nodeid]; |
| 33: | pipe_config = &pipe_config_table[pipe_id]; |
| 34: | |
| 35: | syc_nodeset_iterate(active,nodeid,{ |

| | |
|---|---|
| 36: | if (nbytes_arr[nodeid] != |

sizeof(syc_bwman_shared_pipe_info_exch_t))

| | |
|---|---|
| 37: | slog_msg(SLOG_CRIT,“syc_bwman_shared_pipe_re |

cv_all(INVARIANT
from %d)”,

| | |
|---|---|
| 38: | nodeid); |

| | |
|---|---|
| 39: | else |

| | |
|---|---|
| 40: | syc_memcpy(&pipe−>recv_state[nodeid],buffer_arr |

[nodeid],
nbytes_arr[nodeid]);

| 41: | }); | |
|---|---|---|
| 42: | | |
| 43: | total_bytes_booked | = 0; |

| | | |
|---|---|---|
| 44: | total_bytes_unbooked | = 0; |

| | |
|---|---|
| 45: | syc_nodeset_iterate(active_nodes,nodeid,{ |

| | |
|---|---|
| 46: | syc_bwman_shared_pipe_info_exch_t *recv_state = |

| | |
|---|---|
| 47: | &pipe−>recv_state[nodeid]; |
| 48: | |

| | |
|---|---|
| 49: | total_bytes_booked += recv_state−>bytes_booked |

;

| | |
|---|---|
| 50: | total_bytes_unbooked += recv_state−>bytes_unboo |

ked;

| | |
|---|---|
| 51: | }); |
| 52: | |
| 53: | total_bytes_queued = total_bytes_unbooked + total_{—} |

bytes_booked;
54:

| | |
|---|---|
| 55: | syc_bwman_desc_add_booked_credit(pipe_config); |
| 56: | |
| 57: | |
| 58: | num_active_nodes = syc_nodeset_count(active_node |

s);

| | |
|---|---|
| 59: | if (num_active_nodes= =0) num_active_nodes = 1; |
| 60: | |
| 61: | pipe_config−>shared.nonqueued_bytes = |

| | |
|---|---|
| 62: | (pipe_config−>total_bytes > total_bytes_queued) ? |
| 63: | pipe_config−>total_bytes − total_bytes_queued : 0 ; |
| 64: | |

| | |
|---|---|
| 65: | { |

| | |
|---|---|
| 66: | syc_uint32_t available_this_time = |

| | |
|---|---|
| 67: | pipe_config−>shared.nonqueued_bytes / num_acti |

ve_nodes ;
68:

| | |
|---|---|
| 69: | syc_uint32_t unused_last_time = |

| | |
|---|---|
| 70: | sci_atomic_swap32((syc_uint32_t*)&pipe_config−> |

my.nonqueued_counter,

| | |
|---|---|
| 71: | available_this_time) ; |
| 72: | |

| | |
|---|---|
| 73: | if (pipe_config−>my.overdrawn_counter > 0) { |

| | |
|---|---|
| 74: | (void)sci_atomic_add32((syc_int32_t*)&pipe_config |

−>
my.overdrawn_counter,

| | |
|---|---|
| 75: | − unused_last_time ); |

| | |
|---|---|
| 76: | if (pipe_config−>my.overdrawn_counter < 0) |

| | |
|---|---|
| 77: | pipe_config−>my.overdrawn_counter = 0; |

| | |
|---|---|
| 78: | } |

| | |
|---|---|
| 79: | } |
| 80: | |
| 81: | if (pipe_config−>shared.nonqueued_bytes > 0) { |

| | |
|---|---|
| 82: | pipe_config−>unbooked_share = SYC_BWMAN_PIPE |

_SHARE_MAX;

| | |
|---|---|
| 83: | syc_bwman_desc_add_unbooked_credit(pipe_config |

);
84:

| | |
|---|---|
| 85: | pipe_config−>immediate_credits = |

| | |
|---|---|
| 86: | x_times_y_div_z((pipe_config−>shared.nonqueued |

_bytes),

| | |
|---|---|
| 87: | pipe_config−>immediate_share, |
| 88: | SYC_BWMAN_PIPE_SHARE_MAX) |

| | |
|---|---|
| 89: | / num_active_nodes ; |

| | |
|---|---|
| 90: | syc_bwman_desc_add_immediate_credit(pipe_confi |

g);

| | |
|---|---|
| 91: | } else { |

| | |
|---|---|
| 92: | pipe_config−>immediate_credits = 0 ; |
| 93: | |
| 94: | // Testing that total_bytes_unbooked >0 is theoreti |

cally

| | |
|---|---|
| 95: | // superfluous, but the code is complex and makes |

it hard to

| | |
|---|---|
| 96: | // verify that div by 0 is not possible. |
| 97: | |

| | |
|---|---|
| 98: | if ((total_bytes_booked < pipe_config−>total_bytes) |

&&

| | |
|---|---|
| 99: | (total_bytes_unbooked > 0)) { |

| | |
|---|---|
| 100: | pipe_config−>unbooked_share = |

| | |
|---|---|
| 101: | ;x_times_y_div_z( pipe_config−>total_bytes − total_b |

ytes_booked,

| | |
|---|---|
| 102: | SYC_BWMAN_PIPE_SHARE_MAX, |
| 103: | total_bytes_unbooked); |
| 104: | syc_bwman_desc_add_unbooked_credit(pipe_con |

fig);

| | |
|---|---|
| 105: | } else |

| | |
|---|---|
| 106: | pipe_config−>unbooked_share = 0; |

| | |
|---|---|
| 107: | } |

| | |
|---|---|
| 108: | #ifdef SYC_BWMAN_SHARED_PIPE_STATS |

| | | |
|---|---|---|
| 109: | pipe−>stats.total_bytes | = pipe_config−>total_{—} |

bytes ;

| | |
|---|---|
| 110: | pipe−>stats.sent_booked_bytes = total_bytes_boo |

ked ;

| | |
|---|---|
| 111: | pipe−>stats.sent_unbooked_bytes = |

| | |
|---|---|
| 112: | x_times_y_div_z(total_bytes_unbooked, |

| | |
|---|---|
| 113: | pipe_config−>unbooked_share, |
| 114: | SYC_BWMAN_PIPE_SHARE_MAX); |

| | |
|---|---|
| 115: | pipe−>stats.immediate_bytes = pipe_config−> |

immediate_credits ;

| | |
|---|---|
| 116: | #endif |
| 117: | |

| | |
|---|---|
| 118: | syc_bwman_pipe_tx_pkts(pipe_config); |

| | |
|---|---|
| 119: | } |

As provided at lines 43-51, summaries are calculated across all nodes to give a view of all queued bytes on the current node and its peers. This summary indicates how many bytes are “booked” (i.e., guaranteed under an applicable resource or job policy referred to herein as an “SLA”) and how many are “unbooked” (i.e., not guaranteed) under the SLA. The booked bytes are always sent, so the first action is to give the booked bytes their rightful priority.

If there is any space left, a check is made to see if all the unbooked traffic fits in the space available. If so, the unbooked traffic is queued as well. After the booked and unbooked traffic is queued, any remaining space is shared out as “immediate” credits as illustrated at lines 81-90. Immediate credits enable any node with traffic to send packets in the forthcoming interval. Exactly when these packets will be sent cannot be predicted, however, so these credits are devalued on the basis that one cannot tell if packets will be sent in the first or second half of the interval. The manner in which these credits are devalued can be configured by a user. For example, a user may de-value the credits by 50% (which is the default approach). Alternatively, the user may select 0% which is an “always queue” setting or may select 100% is equivalent to “always take a chance”. This parameter may be set per pipe, and is a user definable characteristic.

Those skilled in the art will appreciate that there are also other alternatives available for allocating remaining bandwidth in this situation. For example, one can detect how much remains of an interval when a packet is to be sent and adjust the valuation accordingly. Also, packets can be scheduled more frequently than information exchanges, so a more fine-grained system clock (if lightweight) may be used when a packet is received asynchronously. In the currently preferred embodiment, the OS packet queue is kept fed with just enough packets to keep it going, so that scheduling decisions can be made “just in time”. The allocation of bandwidth can also take into account whether the full booking was used up and share out extra credit over the next interval to those SLAs which did (or did not) utilize their full booking.

It should be noted that the each of the following aspects of the allocation between nodes sharing a common pipe and SLAs on one of those nodes is identical: “Total”—the total booked and unbooked; “Spend”—the booked and (a share of) unbooked; and “Share”—share out the rest to let packets through as far as possible and coping with the elapsed time by scaling and also by looking at the time in as accurately as possible. The difference at the node level is simply that it represents an upper level of the hierarchy which is updated periodically by the information exchange.

One result of the approach of the present invention is that a lightly loaded system rarely queues anything, and a congested system tends to enqueue everything. As a lightly loaded system becomes more congested during the information exchange interval, some traffic will be throttled until the node can ask its peers for some more bandwidth. Similarly, within a node, some SLAs (applications) may lose out because an application that is a resource hog has been monopolizing the network resources until the next scheduling interval. However, at the next scheduling interval all of the SLAs (applications) should get the resources that they need (i.e., that to which they are entitled based upon the resource policy). If a node is in an overdrawn status (i.e. it used credit in previous iterations which it was not allocated) then the overdraft is paid off with any spare capacity which was allocated in the last interval but was not used.

The several calculations at lines 66-77 above could be combined into a single expression, but are split up for clarity. These calculations can basically be read to be equivalent to the following: “swap what we did use last time with what we can use this time; use the result to pay off the overdraft”. Over the next iteration, this value will be reduced every time something non-queued is sent. This must be atomic given that packets can be sent concurrently with this (information exchange) thread. It is not a problem if there is a race as long as the values are determined correctly. If a packet is sent right on this threshold, it does not matter if the overdraft is affected before or after, just as long as the numbers are correct. At lines 76-77 if the overdraft value is made negative by accident it is reset to zero.

As shown commencing at line 81, if all the unbooked traffic fits in the remaining credit (i.e. there is room for non-queued or “immediate” traffic) then the credit is allocated to it and any remaining credits are degraded by the immediate share so that spare capacity is used as far as possible. After these steps the allocation of bytes can then be transferred. This transfer itself can now be made asynchronously or scheduled at a frequency greater than that of the information exchange.

Resource Policy Management

As previously described, a policy management module deals with jobs and their components—processes and flows. Resource or job policies (referred to herein as “SLAs”) are set up for new jobs, and adjusted for existing jobs as required. Jobs can be categorized based on several criteria including the following: the job may have an SLA (flag “SWM\_JOB\_ROGUE” not set) or not (flag set)—this flag is typically exported in the job descriptor; the job may have child processes forked by their processes that are added automatically to them (flag “SWM\_JOB\_MANAGED” set) or not (flag not set); and/or the job detection rules may be applied to their processes and flows (flag “SWM\_JOB\_DETECT” set) or not (flag not set).

The following “swm_jobs_move_detected_process” function sets up a resource policy for a process or instance of a program, ensures that the process is in the appropriate task and associates the appropriate flags and resource policies (SLA) with the process:

| | |
|---|---|
| 1: | void swm_jobs_move_detected_process(swm_job_id_t j |

ob_id,

| | |
|---|---|
| 2: | swm_process_obj_t process, |
| 3: | int include_child_pids, |
| 4: | swm_job_sla_t *sla, |
| 5: | char *job_name, |
| 6: | int detection_level) { |

| | |
|---|---|
| 7: | swm_task_t *task; |
| 8: | |
| 9: | /*-- 1. Place the process in the appropriate task --*/ |
| 10: | if ((task = lswm_jobs_place_process(job_id, job_nam |

e, process,

| | |
|---|---|
| 11: | detection_level)) = = NULL) |

| | |
|---|---|
| 12: | return; |
| 13: | |

| | |
|---|---|
| 14: | /*-- 2. Update task flags --*/ |
| 15: | if (include_child_pids) |

| | |
|---|---|
| 16: | task−>flags \|= SWM_JOB_MANAGED; |

| | |
|---|---|
| 17: | else |

| | |
|---|---|
| 18: | task−>flags &= ˜SWM_JOB_MANAGED; |
| 19: | |

| | |
|---|---|
| 20: | /*-- 3. Give the task the appropriate SLA --*/ |
| 21: | if (sla && !(task−>flags & SWM_JOB_ADJUSTED) && |

| | |
|---|---|
| 22: | memcmp(&task−>desired_sla, sla, sizeof(*sla)) != |

0) {

| | |
|---|---|
| 23: | task−>desired_sla = *sla; |
| 24: | if (swm_jobs_adjust_task_sla(task) = = 0) |

| | |
|---|---|
| 25: | lswm_update_desired_instance_sla(task); |

| | |
|---|---|
| 26: | } |

| | |
|---|---|
| 27: | } |

As provided at lines 10-11, a process or program is placed in the appropriate task. At lines 15-16, the task's flags are updated. Next, at lines 21-25 the task is made subject to the appropriate SLA (i.e., resource policy).

The following “swm_jobs_adjust_task_sla” function sets the appropriate resource policy (SLA) for a process or job instance (if sufficient resources exist):

| | |
|---|---|
| 1: | int swm_jobs_adjust_task_sla(swm_task_t *task) { |

| | |
|---|---|
| 2: | swm_job_sla_t desired_delta, actual_delta, zero_delta; |
| 3: | swm_jd_t *jd; |
| 4: | int index; |
| 5: | /*-- 1. Calculate desired change in the task actual SLA |

--*/

| | |
|---|---|
| 6: | desired_delta.cpu = task−>desired_sla.cpu − task−>m |

in_cpu;

| | |
|---|---|
| 7: | desired_delta.comm = task−>desired_sla.comm − task |

−>min_comm;

| | |
|---|---|
| 8: | desired_delta.in_bandwidth = |

| | |
|---|---|
| 9: | task−>desired_sla.in_bandwidth − task−>in_bandwid |

th;

| | |
|---|---|
| 10: | desired_delta.out_bandwidth = |

| | |
|---|---|
| 11: | task−>desired_sla.out_bandwidth − task−>out_ban |

dwidth;

| | |
|---|---|
| 12: | if (desired_delta.cpu = = 0 && desired_delta.comm = |

= 0 &&

| | |
|---|---|
| 13: | desired_delta.in_bandwidth = = 0 && |

desired_delta.out_bandwidth = = 0) {

| | |
|---|---|
| 14: | slog_msg(SLOG_DEBUG, “debug: no SLA change req |

uired for
job %llu”,

| | |
|---|---|
| 15: | task−>job_id); |

| | |
|---|---|
| 16: | return 0; |

| | |
|---|---|
| 17: | } |
| 18: | |
| 19: | /*-- 2. Debugging info --*/ |
| 20: | |
| 21: | slog_msg(SLOG_DEBUG, “debug: adjusting SLA of job |

%llu from
(%u CPU, ”

| | |
|---|---|
| 22: | “%u comms, %u in, %u out) to (%u CPU, %u com |

ms,
%u in, %u out)”,

| | |
|---|---|
| 23: | task−>job_id, (unsigned) task−>min_cpu, (unsi |

gned)
task−>min_comm,

| | |
|---|---|
| 24: | (unsigned) task−>in_bandwidth, (unsigned) |

task−>out_bandwidth,

| | |
|---|---|
| 25: | (unsigned) task−>desired_sla.cpu, (unsigned) |

task−>desired_sla.comm,

| | |
|---|---|
| 26: | (unsigned) task−>desired_sla.in_bandwidth, |
| 27: | (unsigned) task−>desired_sla.out_bandwidth); |
| 28: | |

| | |
|---|---|
| 29: | /*-- 3. Mark task as non-rogue --*/ |
| 30: | task−>flags &= ˜SWM_JOB_ROGUE; |
| 31: | |
| 32: | /*-- 4. Change resource bookings --*/ |
| 33: | swm_grid_change_resource_bookings(&desired_delta |

, &actual_delta);

| | |
|---|---|
| 34: | slog_msg(SLOG_DEBUG, “debug: actual delta CPU %d, |

comm %d,
in %d, out %d”,

| | |
|---|---|
| 35: | (int) actual_delta.cpu, (int) actual_delta.comm, |
| 36: | (int) actual_delta.in_bandwidth, |
| 37: | (int) actual_delta.out_bandwidth); |
| 38: | |

| | |
|---|---|
| 39: | /*-- 5. Raise alarm if desired SLA cannot be realised |

--*/

| | |
|---|---|
| 40: | if (memcmp(&desired_delta, &actual_delta, sizeof(des |

ired_delta))
!= 0)

| | |
|---|---|
| 41: | lswm_jobs_insufficient_resources(task−>job_id); |
| 42: | |

| | |
|---|---|
| 43: | /*-- 6. Exit if no change at all was possible --*/ |
| 44: | memset(&zero_delta, 0, sizeof(zero_delta)); |
| 45: | if (memcmp(&zero_delta, &actual_delta, sizeof(zero_{—} |

delta)) = = 0)

| | |
|---|---|
| 46: | return 0; |
| 47: | |

| | |
|---|---|
| 48: | /*-- 7. Update the job descriptor --*/ |
| 49: | |
| 50: | /*-- 7.1. Get job descriptor, reverting changes if an |

error
occurs --*/

| | |
|---|---|
| 51: | if ((jd = swm_jobs_get_descriptor(task−>job_id, SDB_{—} |

UPDATE_LOCK))
= = NULL) {

| | |
|---|---|
| 52: | slog_msg(SLOG_WARNING, “Cannot get descriptor f |

or job %llu in ”

| | |
|---|---|
| 53: | “swm_jobs_adjust_task_sla”, task−>job_id); |

| | |
|---|---|
| 54: | desired_delta.cpu = −actual_delta.cpu; |
| 55: | desired_delta.comm = −actual_delta.comm; |
| 56: | desired_delta.in_bandwidth = −actual_delta.in_band |

width;

| | |
|---|---|
| 57: | desired_delta.out_bandwidth = −actual_delta.out_b |

andwidth;

| | |
|---|---|
| 58: | swm_grid_change_resource_bookings(&desired_delt |

a,
&actual_delta);

| | |
|---|---|
| 59: | return 0; |

| | |
|---|---|
| 60: | } |
| 61: | |
| 62: | /*-- 7.2. Modify SLAs in the job descriptor; mark job |

as
non-rogue --*/

| | |
|---|---|
| 63: | if (!(jd−>flags & SWM_JOB_ADJUSTED)) |

| | |
|---|---|
| 64: | jd−>desired_instance_sla = task−>desired_sla; |

| | |
|---|---|
| 65: | jd−>actual_sla.cpu += actual_delta.cpu; |
| 66: | jd−>actual_sla.comm += actual_delta.comm; |
| 67: | jd−>actual_sla.in_bandwidth += actual_delta.in_ban |

dwidth;

| | |
|---|---|
| 68: | jd−>actual_sla.out_bandwidth += actual_delta.out_b |

andwidth;

| | |
|---|---|
| 69: | index = task−>logic_node_id; |
| 70: | jd−>actual_instance_slas[index].cpu += actual_delta. |

cpu;

| | |
|---|---|
| 71: | jd−>actual_instance_slas[index].comm += actual_del |

ta.comm;

| | |
|---|---|
| 72: | jd−>actual_instance_slas[index].in_bandwidth += |

actual_delta.in_bandwidth;

| | |
|---|---|
| 73: | jd−>actual_instance_slas[index].out_bandwidth += |

actual_delta.out_bandwidth;

| | |
|---|---|
| 74: | jd−>flags &= ˜SWM_JOB_ROGUE; |
| 75: | if (swm_jobs_set_descriptor(jd, SDB_UNLOCK) < 0) { |

| | |
|---|---|
| 76: | slog_msg(SLOG_WARNING, “Cannot set descriptor f |

or job %llu in ”

| | |
|---|---|
| 77: | “swm_jobs_adjust_task_sla”, task−>job_id); |

| | |
|---|---|
| 78: | desired_delta.cpu = −actual_delta.cpu; |
| 79: | desired_delta.comm = −actual_delta.comm; |
| 80: | desired_delta.in_bandwidth = −actual_delta.in_band |

width;

| | |
|---|---|
| 81: | desired_delta.out_bandwidth = −actual_delta.out_b |

andwidth;

| | |
|---|---|
| 82: | swm_grid_change_resource_bookings(&desired_delt |

a,
&actual_delta);

| | |
|---|---|
| 83: | swm_jobs_free_descriptor(jd); |
| 84: | return 0; |

| | |
|---|---|
| 85: | } |
| 86: | |
| 87: | /*-- 7.3. Free job descriptor --*/ |
| 88: | swm_jobs_free_descriptor(jd); |
| 89: | |
| 90: | /*-- 8. Update task actual SLA --*/ |
| 91: | task−>min_cpu += actual_delta.cpu; |
| 92: | task−>min_comm += actual_delta.comm; |
| 93: | task−>in_bandwidth += actual_delta.in_bandwidth; |
| 94: | task−>out_bandwidth += actual_delta.out_bandwidt |

h;
95:

| | |
|---|---|
| 96: | /*-- 9. Set CPU and bandwidth SLAs --*/ |
| 97: | if (actual_delta.cpu != 0 && task−>pids.npids > 0 && |

| | |
|---|---|
| 98: | sds_set_contract(swm_sei_fd, (pid_t) |

task−>pids.pids[0].data.id,

| | |
|---|---|
| 99: | (double)task−>min_cpu / |

(double)swm_resources.cpu) < 0)

| | |
|---|---|
| 100: | slog_msg(SLOG_WARNING, “SDS continual contract |

failed for
job %llu proc %d”

| | |
|---|---|
| 101: | “ (errno %d: %s)”, task−>job_id, (int) |

task−>pids.pids[0].data.id,

| | |
|---|---|
| 102: | errno, strerror(errno)); |

| | |
|---|---|
| 103: | if (actual_delta.comm != 0 && |

| | |
|---|---|
| 104: | lswm_set_bwman_sla_pipe(task, |

| | |
|---|---|
| 105: | SYC_BWMAN_PIPE_ID_INTERNAL, |
| 106: | 0, task−>min_comm) < 0) |

| | |
|---|---|
| 107: | slog_msg(SLOG_WARNING, “Cannot set bwman SL |

A pipe INT for
job %llu (%s)”,

| | |
|---|---|
| 108: | task−>job_id, strerror(errno)); |

| | |
|---|---|
| 109: | if ((actual_delta.in_bandwidth != 0 \|\| |

actual_delta.out_bandwidth != 0) &&

| | |
|---|---|
| 110: | lswm_set_bwman_sla_pipe(task, |

| | |
|---|---|
| 111: | SYC_BWMAN_PIPE_ID_EXTERNAL, |
| 112: | 0, task−>out_bandwidth) < 0) |

| | |
|---|---|
| 113: | slog_msg(SLOG_WARNING, “Cannot set bwman S |

LA pipe EXT for
job %llu (%s)”,

| | |
|---|---|
| 114: | task−>job_id, strerror(errno)); |
| 115: | |

| | |
|---|---|
| 116: | /*-- 10. Return TRUE--*/ |
| 117: | return 1; |

| | |
|---|---|
| 118: | } |

At lines 6-11, the actual change in the task's resource policy (SLA) is calculated. The resource bookings (CPU and bandwidth) are changed at lines 33-37. Recall that the resource “bookings” represent the guaranteed portion of the resources provided to a particular program under a resource policy. At lines 40-41 a check is made to determine if there are sufficient resources to implement the desired policy. If sufficient resources are not available, an alarm is raised (e.g., alert issued to user and/or system log). The function exits and returns 0 at lines 44-46 if no change to the task's resource policy was possible.

If a change can be made, then commencing at line 51 the job descriptor is updated. Lines 51-59 providing for obtaining the job descriptor or reverting if an error occurs. At lines 63-84, the SLAs are modified in the job descriptor and the job is marked as non-rogue. The task's actual resource policy (SLA) is updated at lines 91-94 and the CPU and bandwidth SLAs are set at lines 97-114. The above function returns 1 if the desired SLA (resource policy) was updated in the job descriptor and 0 otherwise.

While the invention is described in some detail with specific reference to a single-preferred embodiment and certain alternatives, there is no intent to limit the invention to that particular embodiment or those specific alternatives. For instance, those skilled in the art will appreciate that modifications may be made to the preferred embodiment without departing from the teachings of the present invention.

1. A method for regulating resource usage by a plurality of programs running on a plurality of machines, the method comprising:
providing a resource policy specifying allocation of resources amongst the plurality of programs;
determining resources available at the plurality of machines;
detecting requests for resources by each of the plurality of programs running on each of the plurality of machines;
periodically exchanging resource information amongst the plurality of machines, the resource information including requests for resources and resource availability at each of the plurality of machines; and
at each of the plurality of machines, allocating resources to each program based upon the resource policy and the resource information.

2. The method of claim 1, wherein said resources include communication resources.

3. The method of claim 2, wherein said communication resources include network bandwidth shared by the plurality of machines.

4. The method of claim 1, wherein said resources include computing resources.

5. The method of claim 4, wherein said computing resources include processing resources available at the plurality of machines.

6. The method of claim 4, wherein said computing resources include memory resources available at the plurality of machines.

7. The method of claim 1, wherein the plurality of programs include an application that is running on a plurality of computers.

8. The method of claim 1, wherein the plurality of programs include an application that is running on a single computer.

9. The method of claim 1, wherein the resource policy includes a rule specifying a percentage of available resources to be allocated to a particular program.

10. The method of claim 1, wherein the resource policy includes a rule specifying a specific quantity of resources to be allocated to a particular program.

11. The method of claim 1, wherein the resource policy is user configurable.

12. The method of claim 1, wherein the resource policy specifies priorities for allocation of resources amongst the plurality of programs.

13. The method of claim 12, wherein the priorities for allocation of resources are automatically adjusted based on occurrence of particular events.

14. The method of claim 1, wherein said detecting step includes detecting each instance of a program running at each of the plurality of machines.

15. The method of claim 1, wherein said detecting step is performed with a frequency established by a user.

16. The method of claim 15, wherein a user can establish a frequency greater than once per second.

17. The method of claim 1, wherein said exchanging step is performed with a frequency established by a user.

18. The method of claim 17, wherein a user can establish a frequency greater than once per second.

19. The method of claim 1, wherein said exchanging step includes exchanging information based on changes in resource availability since a prior exchange of information.

20. The method of claim 1, wherein said exchanging step includes exchanging information based on changes in requests for resources since a prior exchange of information.

21. The method of claim 1, wherein said exchanging step includes using a bandwidth-conserving protocol.

22. The method of claim 1, wherein said allocating step includes regulating usage of resources by each of the plurality of programs.

23. The method of claim 1, wherein said allocating step includes scheduling processing resources at each of the plurality of machines.

24. The method of claim 1, wherein said allocating step includes regulating the volume of communications sent by a particular program.

25. The method of claim 1, wherein said allocating step includes delaying the sending of a communication by a particular program.

26. The method of claim 1, further comprising:
collecting resource information regarding requests for resources and resource availability; and
generating resource utilization information for display to a user based upon the collected resource information.

27. The method of claim 26, further comprising:
automatically suggesting modifications to the resource policy based, at least in part, upon the collected resource information.

28. A computer-readable medium having processor-executable instructions for performing the method of claim 1.

29. A downloadable set of processor-executable instructions for performing the method of claim 1.

30. A system for regulating utilization of computer resources of a plurality of computers, the system comprising:
a plurality of computers having resources to be regulated which are connected to each other through a network;
a monitoring module provided at each computer having resources to be regulated, for monitoring resource utilization and providing resource utilization information to each other connected computer having resources to be regulated;
a manager module providing rules governing utilization of resources available on the plurality of computers and transferring said rules to the plurality of computers; and
an enforcement module at each computer for which resources are to be regulated for regulating usage of resources based on said transferred rules and the resource utilization information received from other connected computers.

31. The system of claim 30, wherein said resources to be regulated include communication resources.

32. The system of claim 30, wherein said resources to be regulated include processing resources.

33. The system of claim 30, wherein said monitoring module at a given computer identifies at least one application running at the given computer.

34. The system of claim 33, wherein said monitoring module detects a request for resources by said at least one application.

35. The system of claim 33, wherein said monitoring module detects a request for network communication by said at least one application.

36. The system of claim 30, wherein said monitoring module at a given computer determines resources available at the given computer.

37. The system of claim 30, wherein said monitoring module at a given computer provides resource utilization information to each other connected computer at a fixed interval.

38. The system of claim 37, wherein said fixed interval is a sub-second interval.

39. The system of claim 37, wherein said fixed interval is configurable by a user.

40. The system of claim 30, wherein said monitoring module at a given computer provides resource utilization information to each other connected computer in response to particular events.

41. The system of claim 30, wherein said resource utilization information provided by said monitoring module includes information regarding requests for communication resources.

42. The system of claim 30, wherein said resource utilization information provided by said monitoring module includes information regarding requests for processing resources.

43. The system of claim 30, wherein said rules provided by said manager module include a rule specifying a percentage of available resources to be allocated to a particular application.

44. The system of claim 30, wherein said rules provided by said manager module include a rule specifying a specific quantity of resources to be allocated to a particular application.

45. The system of claim 30, wherein said manager module permits a user to establish rules governing utilization of resources.

46. The system of claim 30, wherein said monitoring module uses a bandwidth-conserving protocol for providing resource utilization information.

47. The system of claim 30, wherein said enforcement module schedules processing resources at each of the plurality of computers based on said transferred rules and the resource utilization information.

48. The system of claim 30, wherein said enforcement module regulates the volume of communications sent by a particular application.

49. The system of claim 30, wherein said enforcement module regulates the frequency of communication by a particular application.

50. The system of claim 30, further comprising:
a configuration module for a user to establish rules governing utilization of resources.

51. The system of claim 50, wherein said configuration module collects resource utilization information from the plurality of computers.

52. The system of claim 51, wherein said configuration module suggests rules governing utilization of resources based, at least in part, upon the collected resource utilization information.

53. The system of claim 51, wherein said configuration module displays the collected resource utilization information to a user.

54. A method for scheduling communications by a plurality of applications running on a plurality of computers connected to each other through a network, the method comprising:
providing a policy specifying priorities for scheduling communications by the plurality of applications;
periodically determining communication resources available at the plurality of computers;
at each of the plurality of computers, detecting requests to communicate and identifying a particular application associated with each request;
exchanging bandwidth information amongst the plurality of computers, the bandwidth information including applications making the requests to communicate and a measure of communications resources required to fulfill the requests; and
at each of the plurality of computers, scheduling communications based upon the policy and the bandwidth information.

55. The method of claim 54, wherein said communications comprises incoming and outgoing network traffic.

56. The method of claim 54, wherein said communication resources include network bandwidth shared by the plurality of computers.

57. The method of claim 54, wherein said exchanging step occurs at a frequency established by a user.

58. The method of claim 57, wherein a user can establish a frequency greater than once per second.

59. The method of claim 54, wherein said scheduling step includes immediately transmitting all communications if the bandwidth information indicates communication traffic is light.

60. The method of claim 54, wherein said scheduling step includes delaying a portion of the communications if the bandwidth information indicates communication traffic is heavy.

61. The method of claim 60, wherein said scheduling step includes delaying transmission of communications by lower-priority applications.

62. The method of claim 60, wherein said scheduling step includes load balancing.

63. The method of claim 62, wherein said load balancing includes redirecting communications received at a first computer to a second computer.

64. A computer-readable medium having processor-executable instructions for performing the method of claim 54.

65. A downloadable set of processor-executable instructions for performing the method of claim 54.
